(19) United States
(12) Patent Application Publication
(10) Pub. No.: US 2026/0080481 A1
(43) Pub. Date: Mar. 19, 2026

(54) AI-SUPPORTED INTERACTIVE PLATFORMS FOR GENERATING CAPTIVE INSURANCE POLICY PROPOSALS BASED ON STANDARD MARKET INSURACE POLICY DATA

(71) Applicant: Impel Advantage, Inc., Marco Island, FL (US)

(72) Inventors: Christopher P. Ricci, Marco Island, FL (US); Christopher Guidroz, Albufeira (PT)

(21) Appl. No.: 19/240,028

(22) Filed: Jun. 17, 2025

Related U.S. Application Data
(60) Provisional application No. 63/694,386, filed on Sep. 13, 2024.
(60) Provisional application No. 63/770,168, filed on Mar. 11, 2025.

(51) Int. Cl. G06Q 40/08; G06Q 10/107; H04L 51/08

(52) U.S. Cl. CPC G06Q 40/08; G06Q 10/107; H04L 51/08

(57) ABSTRACT

Artificial intelligence (AI) supported interactive platforms for generating captive insurance policy proposals based on standard market insurance policy data are described. An example system includes one or more processors configured to execute machine-readable instructions to ingest standard market insurance policy documents, extract structured policy data from the standard market insurance policy documents, generate a captive insurance policy proposal based on the structured policy data, implement client engagement features configured to facilitate generation and delivery of an email that includes the captive insurance policy proposal as an attachment thereto, and implement a graphical user interface including a dashboard having one or more dashboard layers, the dashboard including first, second, and third areas respectively configured to enable a user of the system to invoke the ingestion of the standard market insurance policy documents, invoke the generation of the captive insurance policy proposal, and invoke the implementation of the client engagement features.

### RELATED APPLICATIONS

This application claims priority to U.S. Provisional Patent Application No. 63/694,386, filed Sep. 13, 2024, and to U.S. Provisional Patent Application No. 63/770,168, filed Mar. 11, 2025. The entireties of U.S. Provisional Patent Application No. 63/694,386 and U.S. Provisional Patent Application No. 63/770,168 are hereby incorporated by reference herein.

### FIELD OF THE DISCLOSURE

This disclosure relates generally to computer-implemented insurance policy platforms that incorporate artificial intelligence (AI) and, more specifically, to AI-supported interactive platforms for generating captive insurance policy proposals based on standard market insurance policy data.

### BACKGROUND

Traditional insurance and financial services operations have long relied on manual processes, fragmented tools, and delayed data cycles to manage client relationships, assess risk, compare policies, and guide claims decisions. Brokers and service providers typically perform extensive data entry, manage communications across disconnected systems, and rely on personal judgment or static data when assisting clients, particularly during critical events such as policy selection, claims resolution, or capital allocation. Such legacy processes often result in inefficiencies, inconsistent client servicing, and delayed insights. For example, brokers may be unable to provide real-time answers or compare policy alternatives dynamically across carriers, limiting their ability to tailor solutions to client-specific risk profiles or evolving needs. Similarly, assessing a client's risk exposure or claim trajectory often requires manual review of historical records, environmental data, or market trends, all of which introduce time delays and increase the likelihood of human error.

As regulatory complexity increases and client expectations shift toward personalized, real-time engagement, traditional insurance platforms are unable to scale or adapt effectively. In addition, existing insurance systems are typically siloed, lacking secure multi-tenant architectures, robust access controls, or integration with third-party data sources such as banking systems, underwriting platforms, or predictive models. This presents challenges not only in operational efficiency but also in compliance, transparency, and data security.

While artificial intelligence (AI), machine learning (ML), and document automation technologies have begun entering the insurance domain, their adoption remains fragmented and limited in scope. Many tools do not integrate seamlessly with broker workflows, fail to provide actionable insights from client data, or lack the regulatory-grade architecture needed for broad deployment across financial services environments. There is a clear need for an intelligent, secure, and scalable platform that automates insurance operations end-to-end, thereby enabling brokers and institutions to dynamically model risk, streamline policy selection, extract data from uploaded documents, track client activity in real time, and guide claims decisions with predictive analytics.

### BRIEF DESCRIPTION OF THE DRAWINGS

FIG. 1 is a block diagram of an example insurance transformation system constructed in accordance with the teachings of this disclosure.

FIG. 2 is a diagram illustrating a first example dashboard layer presented by the user interface of the insurance transformation system of FIG. 1.

FIG. 3 is a diagram illustrating an example interactive discussion window presented by the user interface of the insurance transformation system of FIG. 1.

FIG. 4 is a diagram illustrating a second example dashboard layer presented by the user interface of the insurance transformation system of FIG. 1.

FIG. 5 is a diagram illustrating a third example dashboard layer presented by the user interface of the insurance transformation system of FIG. 1.

FIG. 6 is diagram representing an example knowledge graph implemented nu the insurance transformation system of FIG. 1.

FIG. 7 is a flowchart representative of example machine-readable instructions and/or example operations that may be executed by processor circuitry to implement the insurance transformation system of FIG. 1.

FIG. 8 is a block diagram of an example processor platform including processor circuitry structured to execute and/or instantiate the machine-readable instructions and/or operations of FIG. 7 to implement the insurance transformation system of FIG. 1.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., arc used herein without imputing or otherwise indicating any meaning of priority, physical order, arrangement in a list, and/or ordering in any way, but are merely used as labels and/or arbitrary names to distinguish elements for case of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Standard market insurance arrangements are generally well known. In a standard market insurance arrangement, the insured (e.g., a company or an individual) purchases an insurance policy from an insurer (e.g., an insurance carrier), with the policy risk being transferred to the insurer, and with the insurer retaining profits that may be derived from implementation of the insurance policy. Captive insurance arrangements provide an alternative to such standard market insurance arrangements. In a captive insurance arrangement, an entity (e.g., a company) creates its own insurance subsidiary to own an insurance policy, with the entity then covering the policy risk, and with the entity having control over profits that may be derived from implementation of the insurance policy. In some instances, an existing standard market insurance policy client may be interested in transitioning into a captive insurance policy, and may accordingly be interested in receiving a comparative captive insurance policy proposal identifying benefits that may be attributed to such a transition.

One or more insurance transformation system(s) disclosed herein implement AI-supported interactive platforms configured to generate captive insurance policy proposals based on standard market insurance policy data. In some examples, the disclosed system(s) automate(s) and optimize(s) the process of analyzing existing policies, loss history, and financial feasibility for transitioning into a captive insurance model. Machine learning, real-time data analytics, and automated financial modeling are leveraged to provide brokers and businesses with accurate, customized insurance policy recommendations.

In some examples, the disclosed system(s) extract(s) structured policy data from uploaded insurance documents using AI-powered document processing, which allows for instant digitization and seamless integration with risk assessment models. This enables rapid analysis of policy structures, ensuring that all key terms, exclusions, and conditions are accounted for automatically. In some examples, the disclosed system(s) implement(s) AI-driven risk modeling to analyze historical loss trends, ensuring precise predictions and customized policy structures. By leveraging predictive analytics, the disclosed system(s) can proactively highlight potential risk exposures, allowing brokers to adjust coverage strategies in real time. In some examples, the disclosed system(s) also perform(s) real-time premium and reserve calculations for captive feasibility assessment, reducing manual calculations and human error. Automated financial models continuously update reserve requirements based on policyholder loss history, industry benchmarks, and projected claim frequencies. In some examples, the disclosed system(s) compare(s) captive insurance versus standard and/or traditional insurance cost-effectiveness over time, offering visualized financial insights for better decision-making. The disclosed system(s) provide(s) detailed comparative analytics, incorporating regulatory considerations, tax advantages, and reinsurance options to optimize financial planning.

In some examples, the disclosed system(s) follow(s) a structured, multi-step process designed to streamline the creation of captive insurance proposals. By combining advanced AI-driven document processing with proprietary actuarial models, the disclosed system(s) automate(s) data extraction, policy sorting, and proposal generation. The process is built to handle both single-policy uploads and more complex scenarios where multiple policy documents are processed simultaneously. The workflow ensures that the disclosed system(s) not only extract(s) and organize(s) data efficiently, but also implement(s) business rules and financial models to generate an actionable, dynamic captive insurance proposal.

In some examples, the disclosed system(s) enable(s) a user to upload one or more standard market insurance policy document(s) into the system. With enhanced AI capabilities, the disclosed system(s) allow(s) for batch processing, enabling the user to upload multiple policy documents at once. The disclosed system(s) can handle both similar and mixed policy types (e.g., auto, property, cyber), which are identified and categorized automatically during the extraction process. In some examples, once the documents are uploaded, the disclosed system(s) implement(s) an AI-based processing engine that reads and digitizes the document content. Advanced natural language processing (NLP) models identify structured data fields such as policy numbers, insured names, coverage limits, and deductible amounts. The disclosed system(s) also flag(s) inconsistencies or missing fields, prompting the user for clarification when needed. This ensures that the extracted data is accurate and complete before proceeding.

In some examples, if multiple policies are uploaded, the disclosed system(s) implement(s) machine learning models to identify the type of each policy (e.g., auto, property, cyber) and sort them accordingly. The disclosed system(s) group(s) similar policies together and generate(s) separate policy calculations for each category. For example, if the user uploads two auto policies and one property policy, the disclosed system(s) will automatically generate two separate captive proposals: one for the combined auto policies and one for the property policy. This intelligent sorting reduces manual effort and increases processing efficiency.

In some examples, after extraction, the disclosed system(s) present(s) the structured data to the user for review. The disclosed system(s) highlight(s) any flagged discrepancies and provide(s) contextual guidance to help the user make corrections. The validation process ensures that business-critical data, such as policy effective dates, premiums, and coverage limits, is correct before calculations are performed. The validation process also ensures accurate actuarial model inputs and reliable proposal outputs.

In some examples, after the structured policy data has been extracted and validated, the disclosed system(s) implement(s) an AI-driven discussion layer to enhance user understanding and improve decision-making. The interactive discussion process allows the user to engage in real-time interaction with the disclosed system to clarify policy details, explore different scenarios, and resolve ambiguities before proceeding to calculation.

In some examples, with validated data in place, the disclosed system(s) implement(s) actuarial models and business rules to generate an initial captive insurance policy proposal. The implemented models and rules account for factors such as premium structure, deductible levels, reinsurance requirements, and investment performance. In some examples, the disclosed system(s) evaluate(s) the financial risk profile and projected surplus over a five-year period to create a proposal tailored to the client's business needs.

In some examples, the disclosed system(s) generate(s) an interactive proposal that allows the user to adjust key financial parameters. Users can modify values such as premium, surplus levels, and reinsurance amounts, while the disclosed system(s) dynamically recalculate(s) projected outcomes in real-time. A five-year policy breakdown covering premiums, surplus, annual costs, reinsurance, and investment income is displayed, thereby enabling the user to assess the financial impact of each adjustment immediately.

In some examples, once the proposal is finalized, the disclosed system(s) generate(s) a professional email containing the proposal summary and an attached PDF version of the full policy calculation. The user can enter recipient email addresses directly in the interface and schedule follow-up reminders. In some examples, the disclosed system(s) also log(s) the email activity and status, thereby providing visibility into client engagement and allowing for timely follow-ups.

In some examples, the disclosed system(s) implement(s) a domain-specific knowledge graph that structurally models standard market insurance policies and corresponding captive insurance alternatives. The knowledge graph organizes policy content into nodes representing coverage elements, exclusions, endorsements, deductible terms, and regulatory references, with directed edges indicating relationships among these elements. This enables the system to perform structured queries, validation checks, and real-time risk modeling with greater computational efficiency compared to traditional flat document analysis. The knowledge graph is dynamically updated based on policy ingestion and regulatory changes, thereby maintaining an accurate, machine-interpretable repository of insurance knowledge.

The insurance transformation system(s) disclosed herein provide numerous advantages relative to existing and/or known methodologies for generating captive insurance policy proposals. For example, the disclosed system(s) advantageously eliminate(s) the manual burden of insurance feasibility assessments, reducing analysis time from days to minutes. Unlike traditional actuarial modeling tools which require extensive manual input and professional underwriting knowledge, the disclosed system(s) advantageously provide(s) real-time, self-service analysis to brokers and businesses, thereby making captive insurance more accessible and cost-effective. As another example, the disclosed system(s) advantageously convert(s) complex policy documents into actionable insights instantly, eliminating human errors and inefficiencies. As another example, the disclosed system(s) advantageously eliminate(s) guesswork by dynamically adjusting coverage structures and financial projections with AI-driven insights that have real-time policy discussion, thereby reducing errors and improving proposal precision. As another example, the disclosed system(s) advantageously ensure(s) businesses select the most optimized captive model based on industry intelligence, regulatory alignment, and financial sustainability. As another example, the disclosed system(s) advantageously provides a seamless, end-to-end workflow from data extraction to final document distribution. As another example, the disclosed system(s) advantageously ensure(s) all policy structures remain aligned with evolving legal and financial regulations, reducing compliance risks and penalties. The above-identified features as well as other advantageous features of the insurance transformation system(s) disclosed herein are further described below in connection with the figures of the application.

As used herein, the term “standard market insurance” refers to an insurance arrangement in which the insured (e.g., a company or an individual) purchases an insurance policy from an insurer (e.g., an insurance carrier), with the policy risk being transferred to the insurer, and with the insurer retaining profits that may be derived from implementation of the insurance policy.

As used herein, the term “captive insurance” refers to an insurance arrangement in which an entity (e.g., a company) creates its own insurance subsidiary to own an insurance policy, with the entity then covering the policy risk, and with the entity having control over profits that may be derived from implementation of the insurance policy.

As used herein in an electrical and/or computing context, the term “configured” means arranged, structured, and/or programmed. For example, in the context of processor circuitry configured to perform a specified operation, the processor circuitry is arranged, structured, and/or programmed (e.g., based on machine-readable instructions) to perform the specified operation.

As used herein, the term “in electrical communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuit(s) structured to perform one or more specific operation(s), and/or (ii) one or more general purpose electrical circuit(s) programmable with instructions to perform one or more specific operation(s). Example processor circuitry described herein can include any type(s) and/or any number(s) of processor(s), microprocessor(s), controller(s), microcontroller(s), application specific integrated circuit(s) (ASIC(s)), programmable logic device(s) (PLD(s)), field programmable logic device(s), (FPLD(s)), field programmable gate arrays (FPGA(s)), digital signal processor(s) (DSP(s)), graphics processing unit(s) (GPU(s)), central processor unit(s) (CPU(s)), semiconductor-based (e.g., silicon-based) circuit(s), digital circuit(s), analog circuit(s), logic circuit(s), and/or integrated circuit(s) implemented via any type(s) and/or any number(s) of transistor(s), capacitor(s), diode(s), inductor(s), resistor(s), timer(s), counter(s), printed circuit board(s), connector(s), wire(s), and/or other electrical circuit component(s).

As used herein, the terms “non-transitory computer-readable medium” and “non-transitory computer-readable storage medium” are expressly defined to include any type of computer-readable storage device and/or storage disk and to exclude propagating signals and to exclude transmission media.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

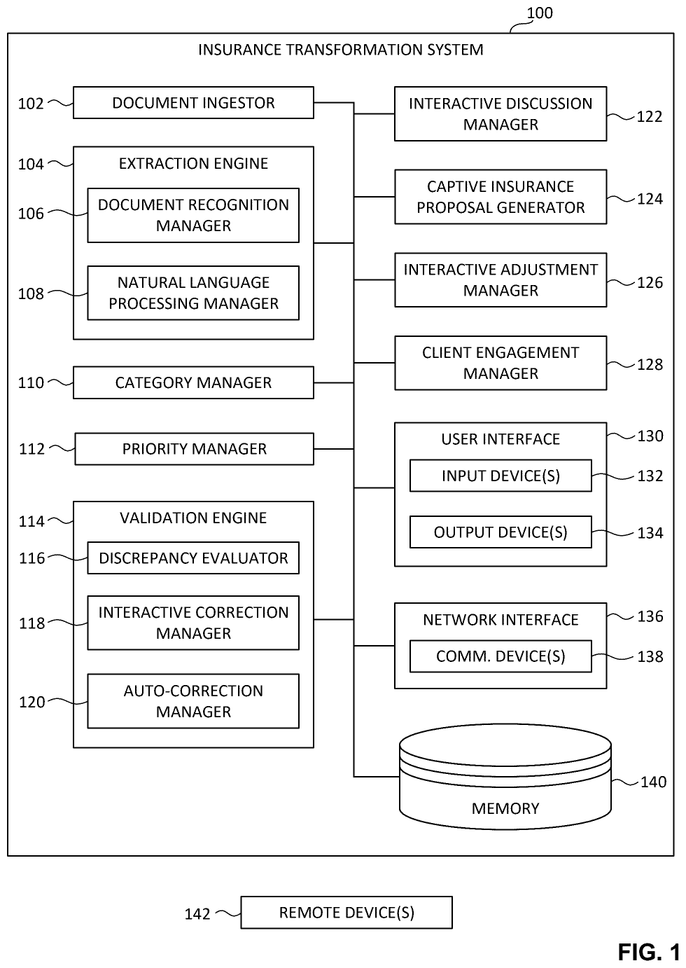

FIG. 1 is a block diagram of an example insurance transformation system 100 constructed in accordance with the teachings of this disclosure. The insurance transformation system 100 can be implemented on a cloud-based platform or as a locally hosted application, and may be accessed via a web-based interface or an application programming interface (API). In some examples, user access to the insurance transformation system 100 is facilitated via a software distribution arrangement (e.g., a software as a service (SaaS) platform). In some examples, the insurance transformation system 100 is structured as a real-time, distributed architecture in which ingestion, extraction, classification, proposal generation, and validation processes (e.g., as further described herein) are implemented as microservices operating asynchronously via a publish/subscribe messaging bus. As soon as document ingestion and partial extraction are complete, downstream modules dynamically receive streamed data updates, enabling incremental proposal drafting without waiting for full document processing. This architecture substantially reduces proposal generation latency and improves system scalability across multiple users and multiple document batches, thereby enhancing the responsiveness and throughput of the insurance transformation platform.

In the illustrated example of FIG. 1, the insurance transformation system 100 includes an example document ingestor 102, an example extraction engine 104 (e.g., including an example document recognition manager 106 and an example natural language processing manager 108), an example category manager 110, an example priority manager 112, an example validation engine 114 (e.g., including an example discrepancy evaluator 116, an example interactive correction manager 118, and an example auto-correction manager 120), an example interactive discussion manager 122, an example captive insurance proposal generator 124, an example interactive adjustment manager 126, an example client engagement manager 128, an example user interface 130 (e.g., including one or more example input device(s) 132 and one or more example output device(s) 134), an example network interface 136 (e.g., including one or more example communication device(s) 138), and example memory 140. In other examples, one or more of the aforementioned components of FIG. 1 can be omitted from the insurance transformation system 100. In still other examples, the insurance transformation system 100 can include one or more other component(s) in addition to or in lieu of the aforementioned components of FIG. 1.

In the illustrated example of FIG. 1, respective ones of the document ingestor 102, the extraction engine 104 (e.g., including the document recognition manager 106 and the natural language processing manager 108), the category manager 110, the priority manager 112, the validation engine 114 (e.g., including the discrepancy evaluator 116, the interactive correction manager 118, and the auto-correction manager 120), the interactive discussion manager 122, the captive insurance proposal generator 124, the interactive adjustment manager 126, and/or the client engagement manager 128 of the insurance transformation system 100 is/are operatively coupled to (e.g., in electrical communication with) one another, and/or to the user interface 130 (e.g., including the input device(s) 132 and the output device(s) 134), the network interface 136 (e.g., including the communication device(s) 138), and/or the memory 140 of the insurance transformation system 100. Respective ones of the document ingestor 102, the extraction engine 104 (e.g., including the document recognition manager 106 and the natural language processing manager 108), the category manager 110, the priority manager 112, the validation engine 114 (e.g., including the discrepancy evaluator 116, the interactive correction manager 118, and the auto-correction manager 120), the interactive discussion manager 122, the captive insurance proposal generator 124, the interactive adjustment manager 126, and/or the client engagement manager 128 of the insurance transformation system 100 is/are also operatively coupled to (e.g., in electrical communication with) the remote device(s) 142 of FIG. 1 via the network interface 136 (e.g., including the communication device(s) 138) of the insurance transformation system 100, as further described below.

The document ingestor 102, the extraction engine 104 (e.g., including the document recognition manager 106 and the natural language processing manager 108), the category manager 110, the priority manager 112, the validation engine 114 (e.g., including the discrepancy evaluator 116, the interactive correction manager 118, and the auto-correction manager 120), the interactive discussion manager 122, the captive insurance proposal generator 124, the interactive adjustment manager 126, and/or the client engagement manager 128 of the insurance transformation system 100 of FIG. 1 respectively implement processor circuitry configured to control and/or manage one or more operation(s) associated with the insurance transformation system 100 of FIG. 1 and/or the components thereof. Such processor circuitry can include any type(s) and/or any number(s) of processor(s), microprocessor(s), controller(s), microcontroller(s), ASIC(s), PLD(s), FPLD(s), FPGA(s), DSP(s), GPU(s), CPU(s), semiconductor-based (e.g., silicon-based) circuit(s), digital circuit(s), analog circuit(s), logic circuit(s), and/or integrated circuit(s) implemented by any type(s) and/or any number(s) of transistor(s), capacitor(s), diode(s), inductor(s), resistor(s), timer(s), counter(s), printed circuit board(s), connector(s), wire(s), and/or other electrical circuit component(s). In some examples, the processor circuitry implemented by and/or otherwise associated with respective ones of the document ingestor 102, the extraction engine 104 (e.g., including the document recognition manager 106 and the natural language processing manager 108), the category manager 110, the priority manager 112, the validation engine 114 (e.g., including the discrepancy evaluator 116, the interactive correction manager 118, and the auto-correction manager 120), the interactive discussion manager 122, the captive insurance proposal generator 124, the interactive adjustment manager 126, and/or the client engagement manager 128 of the insurance transformation system 100 of FIG. 1 can be implemented by and/or as a corresponding processing module configured to perform one or more specific data manipulation and/or processing task(s) corresponding to one or more operation(s) further described herein.

The document ingestor 102 of FIG. 1 ingests, intakes, and/or receives one or more standard market insurance policy document(s) that is/are uploaded and/or otherwise transferred or transmitted to the insurance transformation system 100. Each standard market insurance policy document ingested and/or received by and/or at the document ingestor 102 can itself constitute a standard market insurance policy (or a plurality of standard market insurance policies) or, more broadly, can include information and/or data associated with a standard market insurance policy (or a plurality of standard market insurance policies). Standard market insurance policy documents can be ingested and/or received by the document ingestor 102 either one at a time (e.g., a single-document upload) or as a batch (e.g., a multi-document upload), with such documents including similar and/or mixed policy types (e.g., auto, property, cyber, etc.). Standard market insurance policy documents ingested and/or received by the document ingestor 102 can be structured and/or organized according to any file and/or data structure format including, for example, Portable Document Format (PDF), Joint Photographic Experts Group (JPEG) format, Portable Network Graphics (PNG) format, etc. The intake and/or transfer of standard market insurance policy documents by and/or to the document ingestor 102 of FIG. 1 can be facilitated by the user interface 130 (e.g., including the input device(s) 132 and the output device(s) 134), and/or the network interface 136 of the insurance transformation system 100 of FIG. 1, and can be assisted by a user (e.g., an insurance broker, an insurance client, a system administrator, etc.) having authorization to access the insurance transformation system 100. Standard market insurance policy documents ingested and/or received by and/or at the document ingestor 102 of FIG. 1 can be stored in the memory 140 of FIG. 1. Such documents can be accessed (e.g., either from the memory 140, or alternatively from the document ingestor 102) by other components of the insurance transformation system 100 of FIG. 1 in connection with the performance of various operations associated with such components, as further described herein

The extraction engine 104 of FIG. 1 reads, digitizes, and/or otherwise interprets the standard market insurance policy document(s) ingested and/or received by and/or at the document ingestor 102. As discussed above, the extraction engine 104 includes the document recognition manager 106 and the natural language processing manager 108. The document recognition manager 106 of the extraction engine 104 implements and/or utilizes optical character recognition (OCR) to convert the standard market insurance policy document(s) ingested and/or received by and/or at the document ingestor 102 into machine-readable text. In some examples, the document recognition manager 106 is further enhanced with a custom-trained optical character recognition (OCR) module specialized for insurance policy formatting, including multi-column layouts, tabular schedules, and small-font legal text. The natural language processing manager 108 of the extraction engine 104 implements and/or utilizes natural language processing (NLP) to interpret the meaning and/or context of the machine-readable text identified, generated, and/or output by the document recognition manager 106 of the extraction engine 104. In some examples, the natural language processing (NLP) manager 108 is trained on a proprietary corpus of insurance contracts to optimize entity recognition accuracy for key insurance-specific fields such as coverage limits, loss retention clauses, and jurisdictional endorsements. This domain-adapted preprocessing pipeline improves the accuracy, reliability, and speed of data extraction beyond what can be achieved using conventional OCR and NLP techniques.

The operations performed by the document recognition manager 106, the natural language processing manager 108, and/or, more generally, the extraction engine 104 of FIG. 1 are supported, assisted, guided, and/or driven by AI, ML, and/or other algorithmic techniques that are trained and/or otherwise configured to identify and extract structured policy data (e.g., one or more structured data field(s)) from the standard market insurance policy document(s) ingested and/or received by and/or at the document ingestor 102. For example, the extraction engine 104 can implement and/or utilize AI, ML, and/or other algorithmic techniques that are trained and/or otherwise configured to identify and extract policy numbers, insured names, effective dates, premiums, coverage limits, deductible amounts, etc. from the standard market insurance policy document(s) ingested and/or received by and/or at the document ingestor 102. Data processed, generated and/or output by the document recognition manager 106, the natural language processing manager 108, and/or, more generally, the extraction engine 104 of FIG. 1 can be stored in the memory 140 of FIG. 1. Such data can be accessed (e.g., either from the memory 140, or alternatively from the extraction engine 104) by other components of the insurance transformation system 100 of FIG. 1 in connection with the performance of various operations associated with such components, as further described herein.

The category manager 110 of FIG. 1 categorizes (e.g., identifies, sorts, and groups) the standard market insurance policy documents ingested and/or received by and/or at the document ingestor 102 according to policy type (e.g., auto, property, cyber, etc.). In some examples, the operations performed by the category manager 110 of FIG. 1 incorporate, implement, and/or otherwise utilize data processed, generated and/or output by the document recognition manager 106, the natural language processing manager 108, and/or, more generally, the extraction engine 104 of FIG. 1. The operations performed by the category manager 110 of FIG. 1 are supported, assisted, guided, and/or driven by AI, ML, and/or other algorithmic techniques that are trained and/or otherwise configured to identify a policy type (or multiple policy types) associated with each standard market insurance policy document ingested and/or received by and/or at the document ingestor 102. Either in conjunction with or subsequent to the aforementioned identification operation, the category manager 110 sorts each standard market insurance document based on the identified policy type thereof. Either in conjunction with or subsequent to the aforementioned sorting operation, the category manager 110 groups together respective ones of the sorted standard market insurance documents having a common (e.g., same) policy type.

Different groups of standard market insurance documents categorized by the category manager 110 of FIG. 1 are maintained as separate batches for the purpose of generating one or more captive insurance policy proposal(s). For example, if a user uploads two standard market insurance auto policy documents and one standard market insurance property policy document to the insurance transformation system 100, the category manager 110 of FIG. 1 identifies a first auto policy document, a second auto policy document, and a property policy document, sorts the three policy documents according to their respective identified policy type, and combines the first and second auto policy documents together in an auto policy document group while separately maintaining the property policy document in a property policy document group. In such an example, the insurance transformation system 100 will automatically generate two separate captive insurance policy proposals based on the operations performed by the category manager 110—a first captive insurance policy proposal for the combined first and second auto policy documents, and a second captive insurance policy proposal for the property policy document. Data processed, generated and/or output by the category manager 110 of FIG. 1 can be stored in the memory 140 of FIG. 1. Such data can be accessed (e.g., either from the memory 140, or alternatively from the category manager 110) by other components of the insurance transformation system 100 of FIG. 1 in connection with the performance of various operations associated with such components, as further described herein.

The priority manager 112 of FIG. 1 prioritizes (e.g., ranks) the standard market insurance policy documents ingested and/or received by and/or at the document ingestor 102 according to one or more parameter(s) (e.g., user-defined or system-defined parameter(s)) and/or according to potential risk exposure, thereby ensuring that policies having a relatively high time sensitivity and/or level of risk are prioritized for processing (e.g., processed ahead of other policies having a relatively lower time sensitivity and/or level of risk) by other components of the insurance transformation system 100. In some examples, the operations performed by the priority manager 112 of FIG. 1 incorporate, implement, and/or otherwise utilize data processed, generated and/or output by the document recognition manager 106, the natural language processing manager 108, and/or, more generally, the extraction engine 104 of FIG. 1. The operations performed by the priority manager 112 of FIG. 1 are supported, assisted, guided, and/or driven by AI, ML, and/or other algorithmic techniques that are trained and/or otherwise configured to determine (e.g., to identify, calculate, compute, and or correlate) a priority ranking associated with each standard market insurance policy document ingested and/or received by and/or at the document ingestor 102. Either in conjunction with or subsequent to the aforementioned determination operation, the priority manager 112 ranks (e.g., integrates into an ordered listing) each standard market insurance document based on the determined priority rank thereof. In instances where the priority ranking includes and/or consists of a numerical value, it is to be understood that a relatively “higher” priority rank is dependent upon a defined organizational scheme. For example, in one defined organizational scheme, a lower numerical value within a scale of numerical values (e.g., a value of “1” on a scale of “1” through “10”) may be indicative of a highest priority ranking (e.g., a ranking of “1” is entitled to higher priority than a ranking of “2”), whereas in a second defined organizational scheme, the same lower numerical value within the same scale of numerical values (e.g., a value of “1” on a scale of “1” though “10”) may instead be indicative of a lowest priority (e.g., a ranking of “2” is entitled to higher priority than a ranking of “1”).

Standard market insurance documents prioritized (e.g., ranked) by the priority manager 112 of FIG. 1 are subsequently processed according to (e.g., in order of, with highest priority first) their designated priorities (e.g., determined rankings) in connection with generating one or more captive insurance policy proposal(s). For example, if two separate standard market insurance policy documents are uploaded to the insurance transformation system 100, the priority manager 112 of FIG. 1 separately determines a priority rank for each of the first and second policy documents (e.g., a first priority rank for the first policy document and a second priority rank for the second priority document), and subsequently ranks the first and second policy documents relative to one another based on their corresponding determined policy rankings. If the determined priority ranking of the first policy document is higher than the determined priority ranking of the second policy document, the first policy document will be prioritized (e.g., over and/or ahead of the second policy document) for subsequent processing by the insurance transformation system 100. Conversely, if the determined priority ranking of the first policy document is lower than the determined priority ranking of the second policy document, the second policy document will be prioritized (e.g., over and/or ahead of the first policy document) for subsequent processing by the insurance transformation system 100. Data processed, generated and/or output by the priority manager 112 of FIG. 1 can be stored in the memory 140 of FIG. 1. Such data can be accessed (e.g., either from the memory 140, or alternatively from the priority manager 112) by other components of the insurance transformation system 100 of FIG. 1 in connection with the performance of various operations associated with such components, as further described herein.

The validation engine 114 of FIG. 1 validates the structured policy data extracted by the extraction engine 104. The validation operations performed by the validation engine 114 advantageously ensure that critical data (e.g., structured policy data, such as policy numbers, insured names, effective dates, premiums, coverage limits, deductible amounts, etc.) is accurate and complete prior to the generation of one or more captive insurance policy proposal(s) that is/are developed from actuarial models which incorporate such critical data as inputs thereto. Utilizing such validated critical data in conjunction with such actuarial models advantageously improves the accuracy and/or reliability of the captive insurance policy proposal(s) generated by the insurance transformation system 100. As discussed above, the validation engine 114 includes the discrepancy evaluator 116, the interactive correction manager 118, and the auto-correction manager 120. The discrepancy evaluator 116 of the validation engine 114 implements AI, ML, and/or other algorithmic techniques that are trained and/or otherwise configured to identify discrepancies (e.g., missing, inconsistent, and/or incorrect data) located within the structured policy data, and to provide contextual guidance to assist with the correction of such discrepancies.

In some examples, the identified discrepancies and contextual guidance generated and/or output by the discrepancy evaluator 116 are fed as inputs to the interactive correction manager 118 of the validation engine 114. In such examples, the interactive correction manager 118 implements (e.g., in conjunction with the user interface 130 and/or the network interface 136 of FIG. 1) an interactive correction session with a user (e.g., an insurance broker, an insurance client, a system administrator, etc.) in which the identified discrepancies and contextual guidance are presented to the user along with one or more prompt(s), indication(s), suggestion(s), and/or request(s) inviting the user to either confirm that the referenced structured policy data is correct, or to instead acknowledge that the referenced structured policy data is missing, incomplete, inconsistent, and/or incorrect, and to input additional and/or new information for the purpose of providing corrected data for the referenced structured policy data. In some such examples, the interactive correction session implemented by the interactive correction manager 118 is supported, assisted, guided, and/or driven by AI, ML, and/or other algorithmic techniques that are trained and/or otherwise configured to conduct such an interactive correction session.

In other examples, the identified discrepancies and contextual guidance generated and/or output by the discrepancy evaluator 116 are additionally or alternatively fed as inputs to the auto-correction manager 120 of the validation engine 114. In such examples, the auto-correction manager 120 implements AI, ML, and/or other algorithmic techniques that are trained and/or otherwise configured to either confirm that the referenced structured policy data is correct, or to instead acknowledge that the referenced structured policy data is missing, incomplete, inconsistent, and/or incorrect, and to automatically input additional and/or new information for the purpose of providing corrected data for the referenced structured policy data. Data processed, generated and/or output by the discrepancy evaluator 116, the interactive correction manager 118, the auto-correction manager 120, and/or, more generally, the validation engine 114 of FIG. 1 can be stored in the memory 140 of FIG. 1. Such data can be accessed (e.g., either from the memory 140, or alternatively from the validation engine 114) by other components of the insurance transformation system 100 of FIG. 1 in connection with the performance of various operations associated with such components, as further described herein.

The interactive discussion manager 122 of FIG. 1 implements (e.g., in conjunction with the user interface 130 and/or the network interface 136 of FIG. 1) an interactive discussion session with a user (e.g., an insurance broker, an insurance client, a system administrator, etc.) in which the user is able to engage in real-time interaction with the insurance transformation system 100 for various purposes. For example, utilizing the interactive discussion session implemented by the interactive discussion manager 122, a user can query the insurance transformation system for policy details, request clarification and/or modification of policy details, explore different scenarios in relation to a policy, and/or resolve ambiguities in relation to a policy. In some examples, the operations performed by the interactive discussion manager 122 of FIG. 1 incorporate, implement, and/or otherwise utilize data processed, generated and/or output by the extraction engine 104 and/or the validation engine 114 of FIG. 1. For example, utilizing the interactive discussion session implemented by the interactive discussion manager 122, a user can query, request clarification and/or modification of, explore different scenarios in relation to, and/or resolve ambiguities in relation to the extracted and validated structured policy data that has already been processed, generated and/or output by the extraction engine 104 and/or the validation engine 114 of the insurance transformation system 100.

In some examples, the interactive discussion manager 122 causes the presentation of one or more prompt(s), indication(s), suggestion(s), and/or request(s) inviting and/or encouraging the user to engage the insurance transformation system 100 in conjunction with the interactive discussion session. In some such examples, the interactive discussion session implemented by the interactive discussion manager 122 is supported, assisted, guided, and/or driven by AI, ML, and/or other algorithmic techniques that are trained and/or otherwise configured to conduct such an interactive discussion session. Data processed, generated and/or output by the interactive discussion manager 122 of FIG. 1 can be stored in the memory 140 of FIG. 1. Such data can be accessed (e.g., either from the memory 140, or alternatively from the interactive discussion manager 122) by other components of the insurance transformation system 100 of FIG. 1 in connection with the performance of various operations associated with such components, as further described herein.

The captive insurance proposal generator 124 of FIG. 1 implements actuarial models and business rules that are configured to generate one or more captive insurance policy proposal(s) based on the extracted and validated structured policy data that has already been processed, generated, and/or output by the extraction engine 104 and/or the validation engine 114 of the insurance transformation system 100. The actuarial models and/or business rules implemented by the captive insurance proposal generator 124 account for factors such as premium structures, deductible levels, reinsurance requirements, and investment performance. The actuarial models and/or business rules implemented by the captive insurance proposal generator 124 also evaluate the financial risk profile and projected surplus over a predetermined and/or user-specified time period (e.g., five years) to generate a captive insurance policy proposal that is customized and/or tailored to the business need of the business entity that may ultimately implement and/or own the captive insurance policy that is the subject of the proposal. In some examples, the actuarial models and/or business rules implemented by the captive insurance proposal generator 124 are supported, assisted, guided, and/or driven by AI, ML, and/or other algorithmic techniques that are trained and/or otherwise configured to generate one or more captive insurance policy proposal(s) based on structured policy data that has been extracted by the extraction engine 104 and/or validated by the validation engine 114 of the insurance transformation system 100. In some examples, the captive insurance proposal generator 124 implements a multi-objective optimization framework, training machine learning models with customized loss functions that balance textual fidelity with domain-specific objectives such as regulatory compliance, surplus adequacy, and underwriting standards. For example, the loss function penalizes any generated policy structures that exceed jurisdictional risk retention limits or omit mandatory disclosures. This domain-specific optimization improves the quality, safety, and compliance of generated captive proposals, representing a technological improvement over generic machine learning generation methods. Data processed, generated and/or output by the captive insurance proposal generator 124 of FIG. 1 can be stored in the memory 140 of FIG. 1. Such data can be accessed (e.g., either from the memory 140, or alternatively from the captive insurance proposal generator 124) by other components of the insurance transformation system 100 of FIG. 1 in connection with the performance of various operations associated with such components, as further described herein.

The interactive adjustment manager 126 of FIG. 1 implements (e.g., in conjunction with the user interface 130 and/or the network interface 136 of FIG. 1) an interactive adjustment session with a user (e.g., an insurance broker, an insurance client, a system administrator, etc.) in which the user is able to engage in real-time interaction with a captive insurance policy proposal generated by the captive insurance proposal generator 124 of FIG. 1. For example, utilizing the interactive adjustment session implemented by the interactive adjustment manager 126, a user can simulate different risk scenarios by adjusting and/or modifying one or more data value(s) associated with one or more data source(s) (e.g., premium amounts, deductible amounts, surplus amounts, reinsurance amounts, investment rates and/or amounts, etc.) that is/are included in a captive insurance policy proposal generated by the captive insurance proposal generator 124 of FIG. 1.

The captive insurance proposal generator 124 dynamically recalculates and regenerates an updated version of the previously-generated captive insurance policy proposal in real-time, with such recalculation(s) and/or regeneration(s) being based on the adjustment(s) and/or modification(s) requested by the user during the interactive adjustment session. The recalculated and/or regenerated captive insurance policy proposal is presented to the user in real-time in conjunction with the interactive adjustment session implemented by the interactive adjustment manager 126 so that the user can immediately visualize, interpret, and/or otherwise determine the financial impact of the requested adjustment(s) and/or modification(s) associated with various ones of the different simulated risk scenarios.

In some examples, the interactive adjustment manager 126 causes the presentation of one or more prompt(s), indication(s), suggestion(s), and/or request(s) inviting and/or encouraging the user to engage a captive insurance policy proposal in conjunction with the interactive adjustment session. In some such examples, the interactive adjustment session implemented by the interactive adjustment manager 126 is supported, assisted, guided, and/or driven by AI, ML, and/or other algorithmic techniques that are trained and/or otherwise configured to conduct such an interactive adjustment session. Data processed, generated and/or output by the interactive adjustment manager 126 of FIG. 1 can be stored in the memory 140 of FIG. 1. Such data can be accessed (e.g., either from the memory 140, or alternatively from the interactive adjustment manager 126) by other components of the insurance transformation system 100 of FIG. 1 in connection with the performance of various operations associated with such components, as further described herein.

The client engagement manager 128 of FIG. 1 implements one or more client engagement feature(s) in relation to each captive insurance policy proposal that had been generated by the captive insurance proposal generator 124 of FIG. 1 and subsequently finalized (e.g., accepted and/or authorized by an insurance broker to be delivered to an insurance client). In some examples, the client engagement manager 128 prepares and/or otherwise generates an email including a summary of a captive insurance policy proposal generated by the captive insurance proposal generator 124, and attaches a PDF version of the captive insurance policy proposal to the prepared email. A recipient email address is then added to the prepared email, either via user (e.g., insurance broker) interaction with the client engagement manager 128 and/or, more generally, with the insurance transformation system 100, or automatically from an archived mailing list accessed by the client engagement manager 128. The client engagement manager 128 also facilitates the transmission and/or delivery of prepared emails to their intended and/or targeted recipients (e.g., insurance clients). In some examples, the client engagement manager 128 also facilitates the scheduling of one or more follow-up reminder(s) in relation to any captive insurance policy proposal that has been transmitted and/or delivered to its intended and/or targeted recipient. In some examples, the client engagement manager 128 also logs the various email and scheduling activities facilitated by the client engagement manager 128, thereby providing a historical record of client engagement activities (e.g., client interactions) with full visibility and/or transparency in relation thereto. Such data can be utilized to assist insurance brokers in identifying actionable insights on follow-ups and client interest. Data processed, generated and/or output by the client engagement manager 128 of FIG. 1 can be stored in the memory 140 of FIG. 1. Such data can be accessed (e.g., either from the memory 140, or alternatively from the client engagement manager 128) by other components of the insurance transformation system 100 of FIG. 1 in connection with the performance of various operations associated with such components, as further described herein.

The user interface 130 of FIG. 1 enables a user (e.g., an insurance broker, and insurance client, a system administrator, etc.) of the insurance transformation system 100 to interact with one or more component(s) of the insurance transformation system 100. For example, an insurance broker who is authorized to access the insurance transformation system 100 of FIG. 1 can utilize the user interface 130 to upload standard market insurance policy documents in conjunction with the document ingestor 102, engage and/or interact with extracted structured policy data via an interactive correction session implemented by the interactive correction manager 118 of the validation engine 114, engage and/or interact with validated structured policy data via an interactive discussion session implemented by the interactive discussion manager 122, engage and/or interact with a generated captive insurance policy proposal via an interactive adjustment session implemented by the interactive adjustment manager 126, and/or engage and/or interact with the client engagement manager 128 of the insurance transformation system 100.

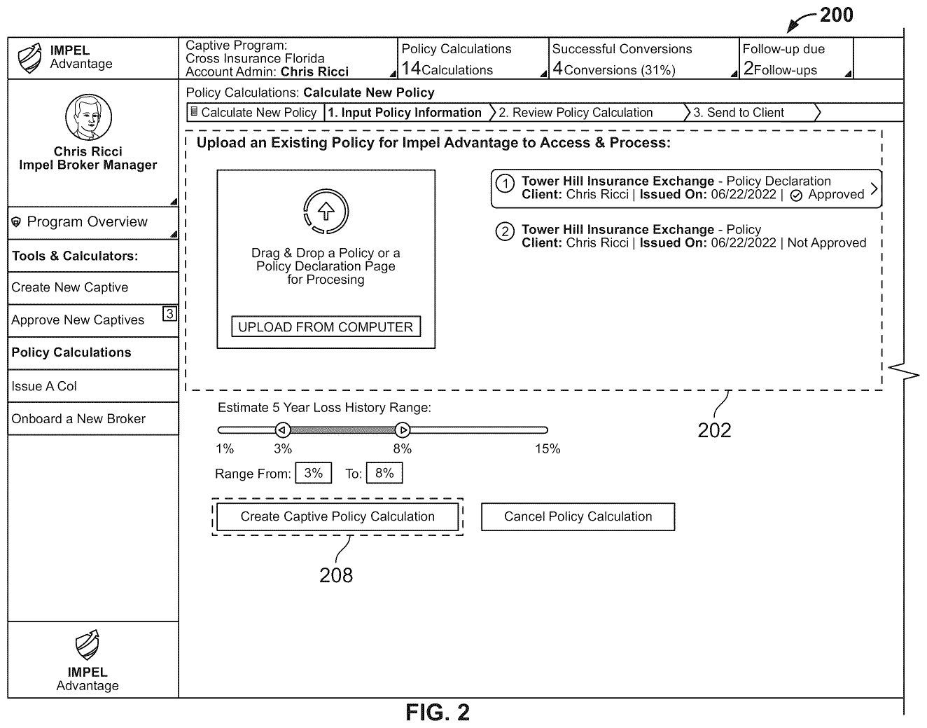

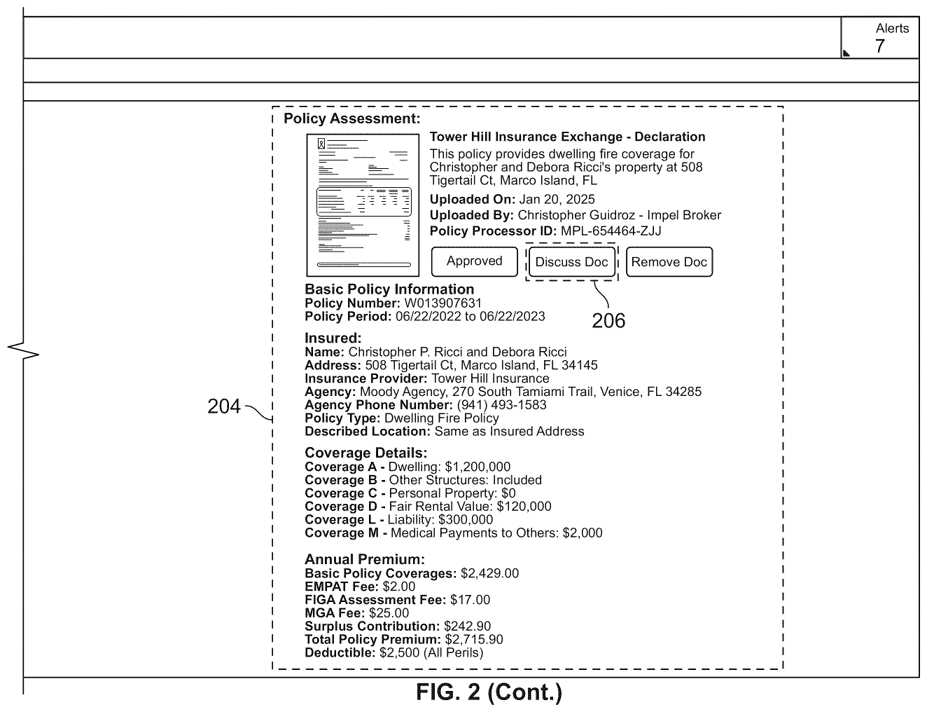

The user interface 130 of FIG. 1 can be implemented as a web-based application (e.g., accessible through a standard browser) or as a dedicated client application, and may present different functional views depending on the role(s) and/or the access permission(s) of a specific user. The user interface 130 is preferably implemented as a graphical user interface that includes one or more dashboard region(s) and/or window(s) configured to invoke one or more operations(s) performed by the insurance transformation system 100, and/or configured to display data and/or information generated by the insurance transformation system 100. Example of such dashboard region(s) and/or window(s) are shown in FIGS. 2-5 and further described below. In some implementations, the user interface 130 supports drag-and-drop document upload, inline editing of data, various interactive components (e.g., charts, sliders, buttons, etc.), and access to one or more modeling configuration panel(s). The user interface 130 is further configured to surface AI-generated recommendations and to allow users to respond to prompts, modify scenario inputs, or initiate communication workflows directly from the same screen. The user interface 130 serves as the primary interaction layer through which users view, query, modify, approve, and export insurance data and decision outputs generated by the insurance transformation system 100.

In the illustrated example of FIG. 1, the user interface 130 is operatively coupled to (e.g., in electrical communication with) the document ingestor 102, the extraction engine 104 (including the document recognition manager 106 and the natural language processing manager 108), the category manager 110, the priority manager 112, the validation engine 114 (e.g., including the discrepancy evaluator 116, the interactive correction manager 118, and the auto-correction manager 120), the interactive discussion manager 122, the captive insurance proposal generator 124, the interactive adjustment manager 126, the client engagement manager 128, the network interface 136 (e.g., including the communication device(s) 138), and/or the memory 140 of the insurance transformation system 100 of FIG. 1. The architecture and/or operations of the user interface 130 of FIG. 1 can be distributed among any number of user interfaces respectively having any number of input device(s) 132 and/or output device(s) 134 located at one or more location(s) in relation to the insurance transformation system 100.

The input device(s) 132 of the user interface 130 of FIG. 1 permit(s) the user of the insurance transformation system 100 to enter, upload, and/or otherwise transmit data, information, documents, selections, parameters, preferences, settings, queries, adjustments, modifications, inputs, instructions, and/or commands into the document ingestor 102, the extraction engine 104 (including the document recognition manager 106 and the natural language processing manager 108), the category manager 110, the priority manager 112, the validation engine 114 (e.g., including the discrepancy evaluator 116, the interactive correction manager 118, and the auto-correction manager 120), the interactive discussion manager 122, the captive insurance proposal generator 124, the interactive adjustment manager 126, the client engagement manager 128, the network interface 136 (e.g., including the communication device(s) 138), and/or the memory 140 of the insurance transformation system 100 of FIG. 1. Such data, information, documents, selections, parameters, preferences, settings, queries, adjustments, modifications, inputs, instructions, and/or commands can cause one or more of the aforementioned component(s) of the insurance transformation system 100 of FIG. 1 to implement (e.g., to initiate, to execute, and/or to terminate) one or more process(es) (e.g., one or more process(es) and/or protocol(s) configured to control one or more operation(s)) of the insurance transformation system 100. The input device(s) 132 of the user interface 130 can be implemented, for example, by one or more of a scanner, a camera, an image sensor, a mouse, a keyboard, a touchscreen, a trackball, a trackpad, a button, a dial, a knob, a switch, an audio sensor, a microphone, and/or a voice recognition system.

The output device(s) 134 of the user interface 130 of FIG. 1 facilitate(s) the presentation of data and/or information (e.g., data and/or information generated, processed, and/or stored by the document ingestor 102, the extraction engine 104 (including the document recognition manager 106 and the natural language processing manager 108), the category manager 110, the priority manager 112, the validation engine 114 (e.g., including the discrepancy evaluator 116, the interactive correction manager 118, and the auto-correction manager 120), the interactive discussion manager 122, the captive insurance proposal generator 124, the interactive adjustment manager 126, the client engagement manager 128, the network interface 136 (e.g., including the communication device(s) 138), and/or the memory 140 of the insurance transformation system 100 of FIG. 1) to the user of the insurance transformation system 100. For example, the output device(s) 134 of the user interface 130 can facilitate the presentation (e.g., textually, graphically, and/or audibly) of data and/or information associated with implementing (e.g., initiating, executing, and/or terminating) one or more process(es) (e.g., one or more process(es) and/or protocol(s) configured to control one or more operation(s)) of the insurance transformation system 100. The output device(s) 134 of the user interface 130 can be implemented, for example, by one or more of a display device (e.g., a light emitting diode (LED), an organic light emitting diode (OLED), a liquid crystal display (LCD), a cathode ray tube (CRT) display, an in-plane switching (IPS) display, a touchscreen, etc.), a tactile output device, and/or a speaker.

FIG. 2 is a diagram illustrating a first example dashboard layer 200 presented by the user interface 130 of the insurance transformation system 100 of FIG. 1. In the illustrated example of FIG. 2, the first dashboard layer 200 includes a first example area 202 configured to enable a user (e.g., an insurance broker) to initiate (e.g., via drag-and-drop functionality) one or more upload(s) for one or more standard market insurance policy document(s). The first area 202 of the first dashboard layer 200 interfaces and/or otherwise communicates with the document ingestor 102 of the insurance transformation system 100 in conjunction with the document ingestor 102 ingesting, intaking, and/or receiving standard market insurance policy documents.

The first dashboard layer 200 of FIG. 2 further includes a second example area 204 configured to enable the user to review, correct, approve, and/or otherwise assess data and/or information associated with one or more standard market insurance policy document(s) that have been uploaded to the insurance transformation system 100, including structured policy data that has been extracted from such document(s) via the extraction engine 104 of the insurance transformation system 100. In some examples, the second area 204 of the first dashboard layer 200 interfaces and/or otherwise communicates with the validation engine 114 of the insurance transformation system 100 in conjunction with the validation engine 114 validating structured policy data extracted by the extraction engine 104.

The first dashboard layer 200 of FIG. 2 further includes a third example area 206 configured to enable the user to request an interactive discussion session associated with one or more standard market insurance policy document(s) that have been uploaded to the insurance transformation system 100, including structured policy data that has been extracted from such document(s) via the extraction engine 104 of the insurance transformation system 100. In some examples, the third area 206 of the first dashboard layer 200 interfaces and/or otherwise communicates with the interactive discussion manager 122 of the insurance transformation system 100 in conjunction with the interactive discussion manager 122 implementing the interactive discussion session requested by the user. In the illustrated example of FIG. 2, the third area 206 of the first dashboard layer 200 is located within the second area 204 of the first dashboard layer 200. In other examples, the third area 206 of the first dashboard layer 200 can be located outside of the second area 204 of the first dashboard layer 200.

The first dashboard layer 200 of FIG. 2 further includes a fourth example area 208 configured to enable the user to request the generation and/or creation of a captive insurance policy proposal that is based on one or more standard market insurance policy document(s) that have been uploaded to the insurance transformation system 100, including structured policy data that has been extracted from such document(s) via the extraction engine 104 of the insurance transformation system 100 and subsequently validated by the validation engine 114 of the insurance transformation system 100. In some examples, the fourth area 208 of the first dashboard layer 200 interfaces and/or otherwise communicates with the captive insurance proposal generator 124 of the insurance transformation system 100 in conjunction with the captive insurance proposal generator 124 generating the captive insurance policy proposal requested by the user.

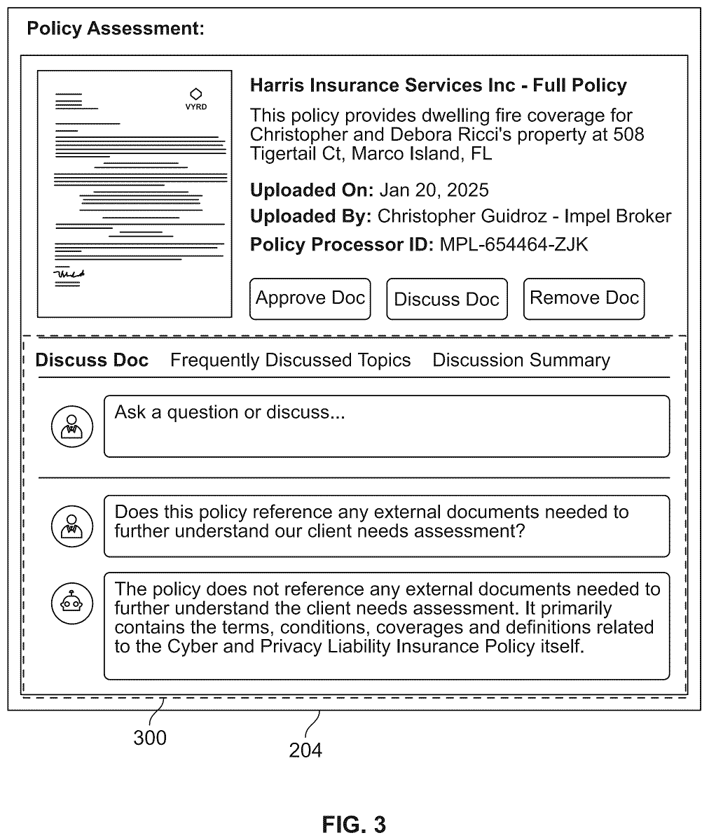

FIG. 3 is a diagram illustrating an example interactive discussion window 300 presented by the user interface 130 of the insurance transformation system 100 of FIG. 1. The interactive discussion window 300 enables the user to engage an interactive and/or conversational AI framework in conjunction with an interactive discussion session implemented by the interactive discussion manager 122 of the insurance transformation system 100. In some examples, the interactive discussion window 300 is configured to appear in the second area 204 of the first dashboard layer 200 of FIG. 2 in response to the user requesting an interactive discussion session associated with one or more standard market insurance policy document(s) that have been uploaded to the insurance transformation system 100, including structured policy data that has been extracted from such document(s) via the extraction engine 104 of the insurance transformation system 100.

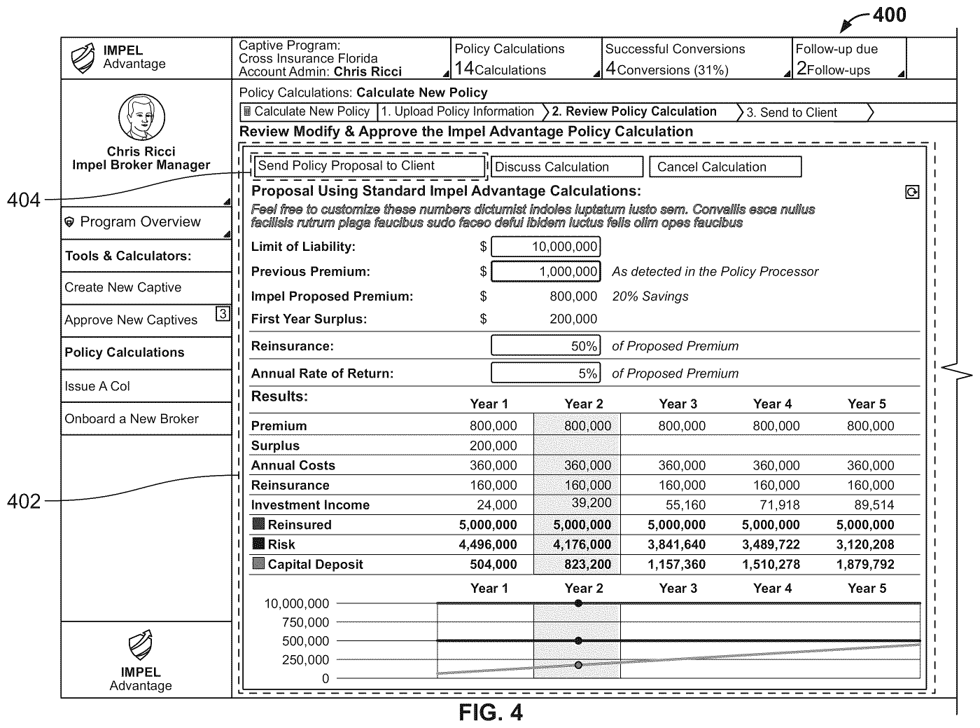

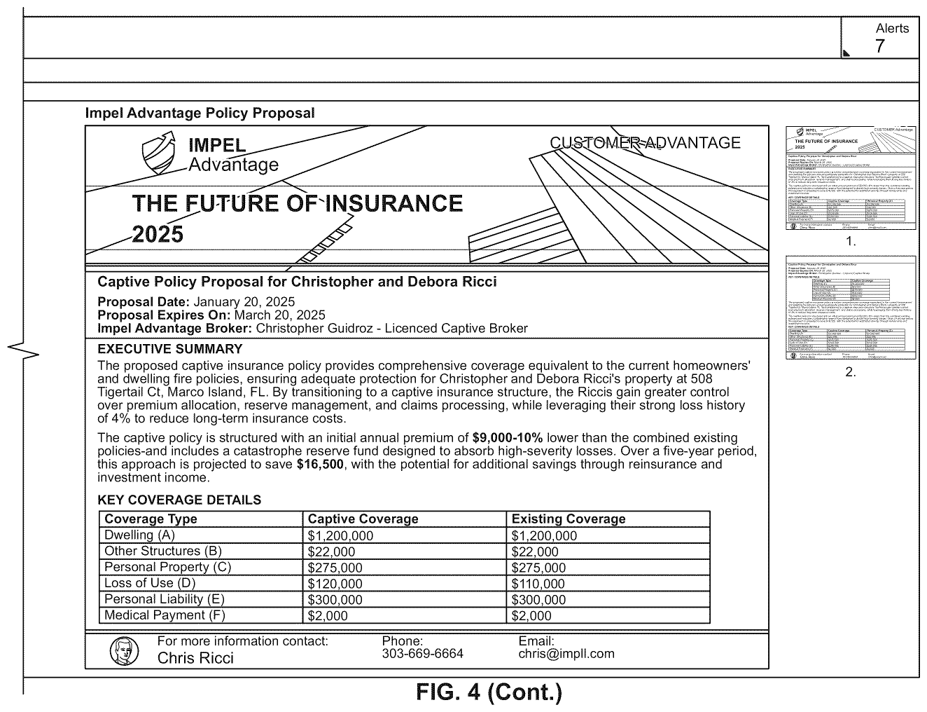

FIG. 4 is a diagram illustrating a second example dashboard layer 400 presented by the user interface 130 of the insurance transformation system 100 of FIG. 1. Although the second dashboard layer 400 of FIG. 4 is distinct from the first dashboard layer 200 of FIG. 2 described above, both dashboard layers (e.g., the first dashboard layer 200 of FIG. 2 and the second dashboard layer 400 of FIG. 4) may be part of a common dashboard presented by the user interface 130. In some such examples, the presentation of the second dashboard layer 400 of FIG. 4 by the user interface 130 is triggered by and/or conditioned upon the completion of one or more task(s) and/or operation(s) associated with the first dashboard layer 200 of FIG. 2. For example, the presentation of the second dashboard layer 400 of FIG. 4 may be triggered by and/or conditioned upon user interaction with the fourth area 208 of the first dashboard layer 200 of FIG. 2 described above.

The second dashboard layer 400 of FIG. 4 is configured to enable a user (e.g., an insurance broker) to review, adjust, modify, approve, and/or otherwise assess data and/or information associated with a captive insurance policy proposal that has been generated by the captive insurance proposal generator 124 of the insurance transformation system 100. For example, the second dashboard layer 400 of FIG. 4 includes a first example area 402 configured to enable the user to adjust and/or modify liability limit amounts, premium amounts, surplus amounts, reinsurance amounts, and/or investment rates that are included in the captive insurance policy proposal generated by the captive insurance proposal generator 124, with such interactive data being presented in conjunction with an interactive adjustment session implemented by the interactive adjustment manager 126 of the insurance transformation system 100. In some examples, the first area 402 of the second dashboard layer 400 interfaces and/or otherwise communicates with the captive insurance proposal generator 124 and/or the interactive adjustment manager 126 of the insurance transformation system 100 in conjunction with the captive insurance proposal generator 124 regenerating one or more updated version(s) of the originally-presented captive insurance policy proposal, with such updates being based on the adjustment(s) and/or modification(s) requested by the user in conjunction with the interactive adjustment session implemented by the interactive adjustment manager 126.

The second dashboard layer 400 of FIG. 4 further includes a second example area 404 configured to enable the user to request that a finalized and/or approved captive insurance policy proposal be sent, delivered, and/or otherwise transmitted to a client (e.g., a potential owner of the captive insurance policy). In some examples, the second area 404 of the second dashboard layer 400 interfaces and/or otherwise communicates with the client engagement manager 128 of the insurance transformation system 100 in conjunction with the client engagement manager 128 implementing one or more client engagement feature(s) of the insurance transformation system 100. In the illustrated example of FIG. 4, the second area 404 of the second dashboard layer 400 is located within the first area 402 of the second dashboard layer 400. In other examples, the second area 404 of the second dashboard layer 400 can be located outside of the first area 402 of the second dashboard layer 400.

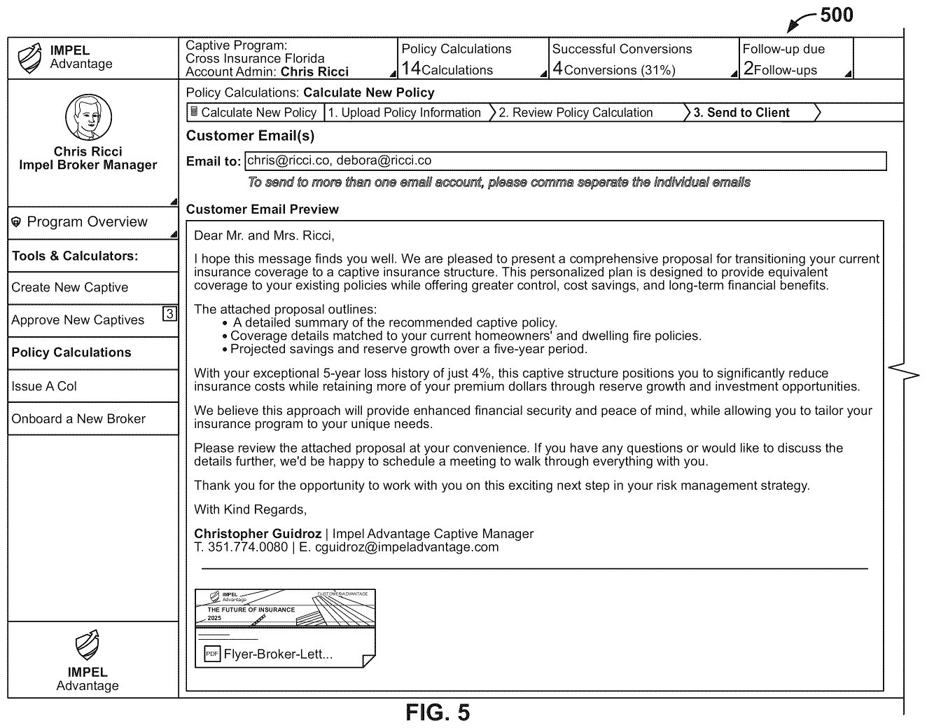

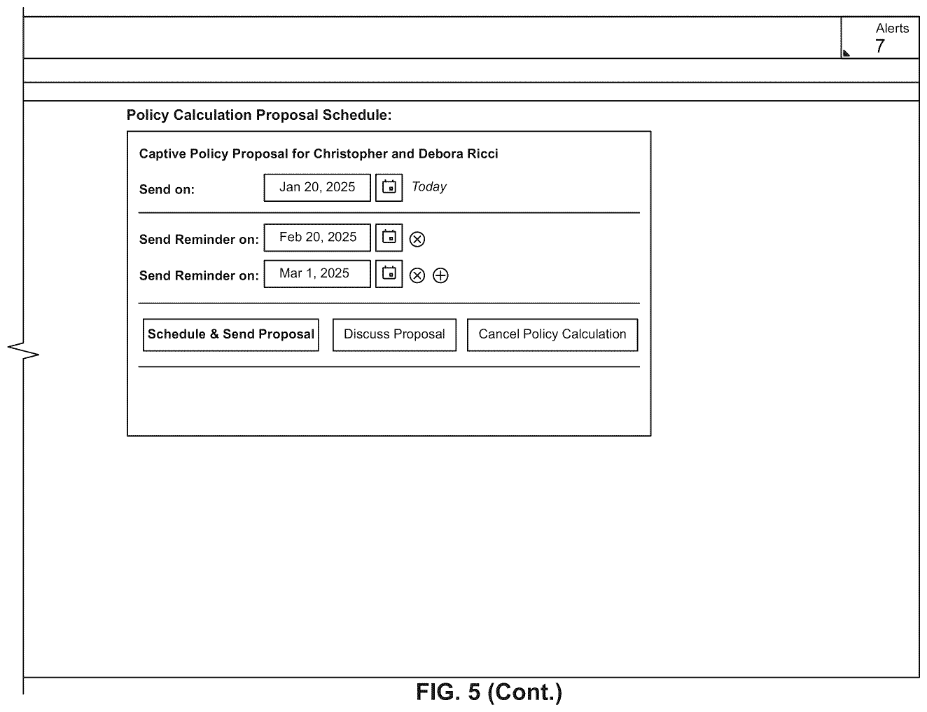

FIG. 5 is a diagram illustrating a third example dashboard layer 500 presented by the user interface 130 of the insurance transformation system 100 of FIG. 1. Although the third dashboard layer 500 of FIG. 5 is distinct from the first dashboard layer 200 of FIG. 2 and the second dashboard layer 400 of FIG. 4 described above, all three dashboard layers (e.g., the first dashboard layer 200 of FIG. 2, the second dashboard layer 400 of FIG. 4, and the third dashboard layer 500 of FIG. 5) may be part of a common dashboard presented by the user interface 130. In some such examples, the presentation of the third dashboard layer 500 of FIG. 5 by the user interface 130 is triggered by and/or conditioned upon the completion of one or more task(s) and/or operation(s) associated with the second dashboard layer 400 of FIG. 4. For example, the presentation of the third dashboard layer 500 of FIG. 5 may be triggered by and/or conditioned upon user interaction with the second area 404 of the second dashboard layer 400 of FIG. 4 described above.

The third dashboard layer 500 of FIG. 5 is configured to enable a user (e.g., an insurance broker) to input client engagement details (e.g., a client email address, an email delivery date, one or more reminder date(s), etc.) in relation to the delivery and/or transmission of one or more communication(s) (e.g., one or more email(s)) including a finalized and/or approved captive insurance policy proposal and/or information pertaining thereto. In some examples, one or more area(s) (e.g., one or more data input field(s)) of the third dashboard layer 500 interface(s) and/or otherwise communicate(s) with the client engagement manager 128 of the insurance transformation system 100 in conjunction with the client engagement manager 128 implementing one or more client engagement feature(s) of the insurance transformation system 100.

Incorporation of the above-described features, characteristics, and functionalities of the user interface 130 of FIG. 1—and in particular the above-described features, characteristics, functionalities, configurations, arrangements, layouts, and/or structuring of the respective dashboard layers (e.g., the first dashboard layer 200, the second dashboard layer 400, and the third dashboard layer 500, as shown and described in connection with FIGS. 2-5) of the user interface 130—into the insurance transformation system 100 of FIG. 1 provides for a computer-implemented solution that is far more dynamic, efficient, reliable, and user intuitive relative to known solutions. These improvements and/or benefits are achieved not by the mere use of a computer system, but instead by virtue of the transformative effect that the features, characteristics, and functionalities of the above-described user interface 130 provide to the insurance transformation system 100 as a whole. In this regard, incorporation of the above-described features, characteristics, and functionalities of the user interface 130 of FIG. 1—and in particular the above-described features, characteristics, functionalities, configurations, arrangements, layouts, and/or structuring of the respective dashboard layers (e.g., the first dashboard layer 200, the second dashboard layer 400, and the third dashboard layer 500, as shown and described in connection with FIGS. 2-5) of the user interface 130—into the insurance transformation system 100 of FIG. 1 constitutes a software-based innovation that improves the performance of the of the computer-implemented insurance transformation system 100 of FIG. 1 itself.

Returning to the illustrated example of FIG. 1, the network interface 136 of FIG. 1 enables a user (e.g., an insurance broker, an insurance client, a system administrator, etc.) of the insurance transformation system 100 to remotely interact (e.g., via one or more of the remote device(s) 142) with the insurance transformation system 100. In the illustrated example of FIG. 1, the network interface 136 is operatively coupled to (e.g., in electrical communication with) the document ingestor 102, the extraction engine 104 (e.g., including the document recognition manager 106 and the natural language processing manager 108), the category manager 110, the priority manager 112, the validation engine 114 (e.g., including the discrepancy evaluator 116, the interactive correction manager 118, and the auto-correction manager 120), the interactive discussion manager 122, the captive insurance proposal generator 124, the interactive adjustment manager 126, the client engagement manager 128, the user interface 130 (e.g., including the input device(s) 132 and the output device(s) 134), and/or the memory 140 of the insurance transformation system 100 of FIG. 1.

The network interface 136 of FIG. 1 includes one or more communication device(s) 138 (e.g., transmitter(s), receiver(s), transceiver(s), modem(s), gateway(s), wireless access point(s), etc.) to facilitate the exchange of data with external machines (e.g., computing devices of any kind, including the remote device(s) 142 of FIG. 1) by a wired or wireless communication network. Communications transmitted and/or received via the communication device(s) 138 and/or, more generally, via the network interface 136 can be made over and/or carried by, for example, an Ethernet connection, a digital subscriber line (DSL) connection, a telephone line connection, a coaxial cable system, a satellite system, a wireless system, a cellular telephone system, an optical connection, etc. The architecture and/or operations of the network interface 136 of FIG. 1 can be distributed among any number of network interfaces respectively having any number of communication device(s) 138 located at one or more location(s) in relation to the insurance transformation system 100.

The memory 140 of FIG. 1 can be implemented by any type(s) and/or any number(s) of storage device(s) such as an optical storage device, a magnetic storage device, a floppy disk drive, a hard disk drive (HDD), a solid state storage device, a flash memory, a read-only memory (ROM), a random-access memory (RAM), a volatile memory, a non-volatile memory, a cache, a CD, a DVD, a Blu-ray disk, and/or any other tangible storage device or tangible storage disk in which information is stored for any duration (e.g., permanently, for extended time periods, for brief instances, for temporarily buffering, and/or for caching of the information). The information and/or data stored in the memory 140 of FIG. 1 can be stored in any file and/or data structure format, organization scheme, and/or arrangement. The memory 140 of FIG. 1 is accessible to and/or is operatively coupled to (e.g., in electrical communication with) the document ingestor 102, the extraction engine 104 (e.g., including the document recognition manager 106 and the natural language processing manager 108), the category manager 110, the priority manager 112, the validation engine 114 (e.g., including the discrepancy evaluator 116, the interactive correction manager 118, and the auto-correction manager 120), the interactive discussion manager 122, the captive insurance proposal generator 124, the interactive adjustment manager 126, the client engagement manager 128, the user interface 130 (e.g., including the input device(s) 132 and the output device(s) 134), and/or the network interface 136 (e.g., including the communication device(s) 138) of the insurance transformation system 100 of FIG. 1.

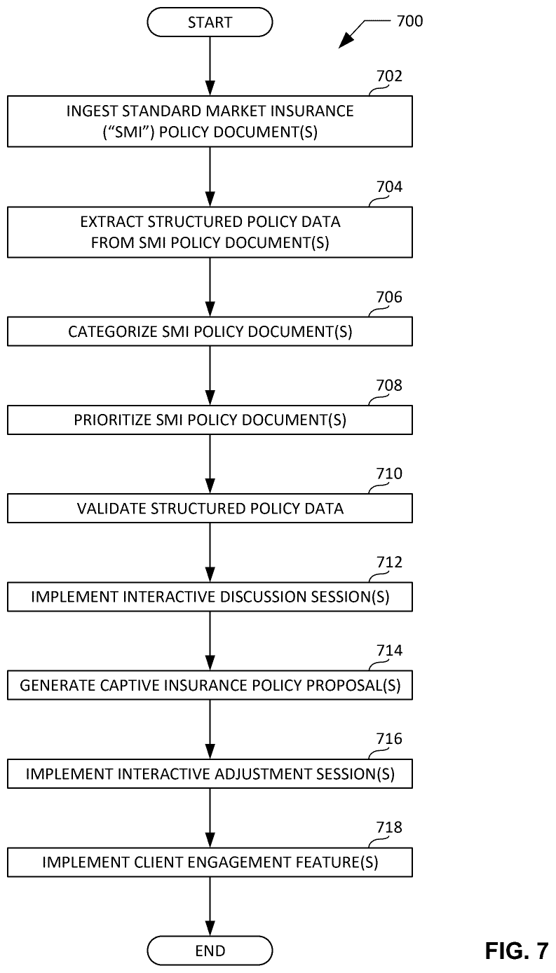

The memory 140 of FIG. 1 stores data received, extracted, identified, detected, determined, computed, calculated, processed, generated, presented, input, output, and/or transmitted—by, to, and/or from—the document ingestor 102, the extraction engine 104 (e.g., including the document recognition manager 106 and the natural language processing manager 108), the category manager 110, the priority manager 112, the validation engine 114 (e.g., including the discrepancy evaluator 116, the interactive correction manager 118, and the auto-correction manager 120), the interactive discussion manager 122, the captive insurance proposal generator 124, the interactive adjustment manager 126, the client engagement manager 128, the user interface 130 (e.g., including the input device(s) 132 and the output device(s) 134), and/or the network interface 136 (e.g., including the communication device(s) 138) of the insurance transformation system 100 of FIG. 1. In some examples, the memory 140 stores uploaded and/or ingested standard market insurance policy documents, extracted and/or validated structure policy data, policy categorization data (e.g., policy type identifications, sorts, and/or groupings), policy prioritization data (e.g., priority rankings), identified data discrepancies, data discrepancy corrections, user-requested queries, captive insurance policy proposals, user-requested data adjustments and/or modifications, and/or client engagement data and communications. The memory 140 of FIG. 1 also stores instructions (e.g., computer-readable instructions) and associated data corresponding to one or more protocol(s), process(es), program(s), sequence(s), subroutine(s), method(s), and/or operation(s) described below in connection with FIG. 7.

The remote device(s) 142 of FIG. 1 can be implemented by any type(s) and/or any number(s) of mobile or stationary computing devices, including any peripherals (e.g., input devices and/or output devices) operatively coupled thereto. In this regard, examples of such remote device(s) 142 include a smartphone, a tablet, a laptop, a desktop, a network server, a cloud server, etc. The remote device(s) 142 of FIG. 1 facilitate(s) a remote (e.g., wired, or wireless) extension of the above-described user interface 130 of the insurance transformation system 100. In this regard, any of the remote device(s) 142 can include one or more input device(s) and/or one or more output device(s) that mimic and/or enable a remotely-located version of the above-described functionality of the corresponding input device(s) 132 and/or the corresponding output device(s) 134 of the user interface 130 of the insurance transformation system 100. Accordingly, one or more input(s), selection(s), instruction(s), and/or command(s) received at the insurance transformation system 100 (e.g., via the communication device(s) 138 of the network interface 136) from any of the remote device(s) 142 can be entered and/or made via the input device(s) of the remote device(s) 142 much in the same way that such input(s), selection(s), instruction(s), and/or command(s) would be entered and/or made via the input device(s) 132 of the user interface 130 of the insurance transformation system 100. Similarly, data and/or information transmitted from the insurance transformation system 100 (e.g., via the communication device(s) 138 of the network interface 136) to any of the remote device(s) 142 can be presented via the output device(s) of the remote device(s) 142 much in the same way that such data and/or information would be presented via the output device(s) 134 of the user interface 130 of the insurance transformation system 100.

While an example manner of implementing the insurance transformation system 100 is illustrated in FIG. 1, one or more of the elements, processes, and/or devices illustrated in FIG. 1 may be combined, divided, re-arranged, omitted, eliminated, and/or implemented in any other way. Further, the document ingestor 102, the extraction engine 104 (e.g., including the document recognition manager 106 and the natural language processing manager 108), the category manager 110, the priority manager 112, the validation engine 114 (e.g., including the discrepancy evaluator 116, the interactive correction manager 118, and the auto-correction manager 120), the interactive discussion manager 122, the captive insurance proposal generator 124, the interactive adjustment manager 126, the client engagement manager 128, the user interface 130 (e.g., including the input device(s) 132 and the output device(s) 134), the network interface 136 (e.g., including the communication device(s) 138), the memory 140, and/or, more generally, the insurance transformation system 100 of FIG. 1, may be implemented by hardware alone or by hardware in combination with software and/or firmware. Thus, for example, any of the document ingestor 102, the extraction engine 104 (e.g., including the document recognition manager 106 and the natural language processing manager 108), the category manager 110, the priority manager 112, the validation engine 114 (e.g., including the discrepancy evaluator 116, the interactive correction manager 118, and the auto-correction manager 120), the interactive discussion manager 122, the captive insurance proposal generator 124, the interactive adjustment manager 126, the client engagement manager 128, the user interface 130 (e.g., including the input device(s) 132 and the output device(s) 134), the network interface 136 (e.g., including the communication device(s) 138), the memory 140, and/or, more generally, the insurance transformation system 100 of FIG. 1, could be implemented at least in part by processor circuitry including any type(s) and/or any number(s) of processor(s), microprocessor(s), controller(s), microcontroller(s), ASIC(s), PLD(s), FPLD(s), FPGA(s), DSP(s), GPU(s), CPU(s), semiconductor-based (e.g., silicon-based) circuit(s), digital circuit(s), analog circuit(s), logic circuit(s), and/or integrated circuit(s) implemented by any type(s) and/or any number(s) of transistor(s), capacitor(s), diode(s), inductor(s), resistor(s), timer(s), counter(s), printed circuit board(s), connector(s), wire(s), and/or other electrical circuit component(s). Further still, the insurance transformation system 100 of FIG. 1 may include one or more element(s), component(s), and/or device(s) in addition to, or instead of, those illustrated in FIG. 1, and/or may include more than one of any or all of the illustrated element(s), component(s), and/or device(s).

In some examples, the insurance transformation system 100 of FIG. 1 is implemented on a cloud-based platform that facilitates distribution of one or more component(s), aspect(s), and/or feature(s) of the insurance transformation system 100 via a software as a service (SaaS) arrangement. In some examples, one or more front-end component(s), aspect(s), and/or feature(s) of the insurance transformation system 100 of FIG. 1 is/are implemented by Next.js and/or React. Next.js offers built-in optimizations for performance, critical for delivering a smooth user experience in a multi-tenant SaaS platform. React enables a dynamic and responsive interface, ensuring usability for clients across the insurance and financial services space. In some examples, one or more back-end component(s), aspect(s), and/or feature(s) of the insurance transformation system 100 of FIG. 1 is/are implemented by Node.js and/or Prisma. Node.js provides a scalable, high-performance backend, ideal for handling complex workflows and integrations common in financial systems. Prisma is desirable for database management due to its flexibility, type safety, and seamless integration with PostgreSQL, ensuring efficient handling of structured data.

In some examples, the insurance transformation system 100 of FIG. 1 implements role-level security to ensure that tenant data remains securely isolated while supporting various access levels. This approach meets the regulatory and operational demands of insurance and financial services organizations, where data privacy and user permissions are critical. In some examples, the insurance transformation system 100 implements tenant-specific data isolation by provisioning independent containerized processing environments for each user session. Policy documents, structured data, and proposal outputs are encrypted both at rest and in transit, and decryption occurs solely within secure enclave environments protected by hardware-assisted memory isolation. Additionally, the insurance transformation system 100 continuously cross-references generated captive proposals against a compliance rules database that captures jurisdiction-specific insurance regulations and underwriting guidelines. Each proposal is automatically logged in an immutable audit trail with cryptographic hashes to ensure traceability and tamper-evidence. In some examples, the insurance transformation system further supports explainable AI outputs by annotating generated proposals with machine-readable references to source clauses, applicable regulations, and policy transformation rationales.

In some examples, the insurance transformation system 100 of FIG. 1 implements one or more internal data structure(s) that model(s) insurance policies as a structured, machine-interpretable knowledge graph. The knowledge graph captures key policy components (e.g., coverage terms, exclusions, deductibles, endorsements, limits, regulatory constraints, etc.) as distinct entities (nodes), and defines their interdependencies and logical relationships (edges). Each policy ingested into the insurance transformation system 100 is parsed and mapped into the knowledge graph using domain-trained NLP and rule-based extractors. The knowledge graph enables advanced AI reasoning capabilities. For example, when implementing the knowledge graph, the insurance transformation system 100 can perform clause-level comparisons across policies, simulate the legal impact of endorsements, identify coverage gaps, and apply policy transformation logic in a rules-aware manner. Unlike flat document representations, the knowledge graph architecture supports semantic queries and enables continuous validation of policy integrity and compliance throughout the generation process. This structural approach represents a substantial and concrete improvement in the ability of a computer to analyze and manipulate legal insurance documents in real time.

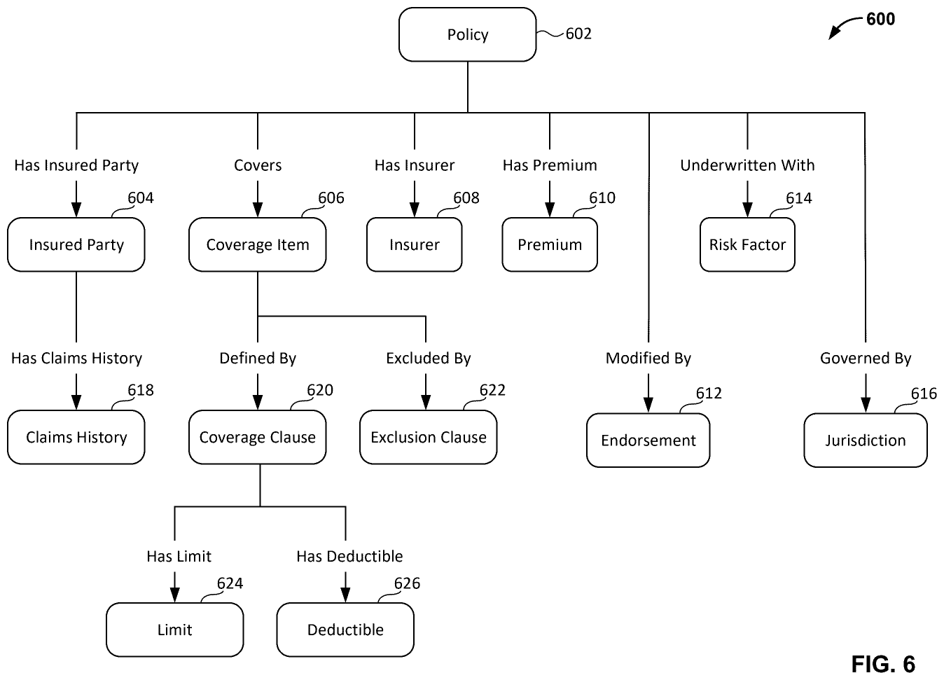

FIG. 6 is diagram representing an example knowledge graph 600 implemented by the insurance transformation system of FIG. 1. The knowledge graph 600 of FIG. 6 includes a plurality of entity classes structured as nodes, with entity class and/or node representing a real-world concept, clause, or term typically found in insurance policies. For example, as shown in FIG. 6, the knowledge graph 600 includes an example “Policy” node 602, an example “Insured Party” node 604, an example “Coverage Item” node 606, an example “Insurer” node 608, an example “Premium” node 610, an example “Endorsement” node 612, an example “Risk Factor” node 614, an example “Jurisdiction” node 616, an example “Claims History” node 618, an example “Coverage Clause” node 620, an example “Exclusion Clause” node 622, an example “Limit” node 624, and an example “Deductible” node 626. Table 1 below provides a listing of the aforementioned entity classes and/or nodes of the knowledge graph 600, along with an associated description for each such entity class and/or node.

TABLE 1
Entity Classes (Nodes)

| Entity Class | Description |
|---|---|
| Policy | Top-level document entity. Contains metadata and |
| | links to all sub-components. |
| Insured Party | The individual or organization covered by the policy. |
| Coverage Item | Specific things being insured (e.g., property, vehicles, |
| | cyber risk). |
| Insurer | The issuing carrier or captive entity. |
| Premium | Cost paid for the policy. |
| Endorsement | Amendments that add or remove coverage. |
| Risk Factor | Environmental or business-specific factors used in |
| | underwriting. |
| Jurisdiction | Legal/geographic scope under which the policy is |
| | governed. |
| Claims History | Historical data of past claims related to the insured or |
| | similar policies. |
| Coverage | Defines terms under which coverage is granted. |
| Clause | |
| Exclusion | Specifies what is not covered. |
| Clause | |
| Limit | Maximum financial liability of the insurer. |
| Deductible | Amount the insured must pay before coverage applies. |

In other examples, the knowledge graph 600 can include additional entity classes and/or nodes beyond those illustrated in FIG. 6. In still other examples, one or more of the entity classes and/or nodes illustrated in FIG. 6 can be omitted from the knowledge graph 600.

The knowledge graph 600 of FIG. 6 further includes a plurality of relations structured as edges, with each relation and/or edge defining how various ones of the entity classes and/or nodes are semantically connected to one another. In the illustrated example of FIG. 6, the “Policy” node 602 is a first tier node. The example “Insured Party” node 604, the “Coverage Item” node 606, the “Insurer” node 608, the “Premium” node 610, the “Endorsement” node 612, the “Risk Factor” node 614, and the “Jurisdiction” node 616 are second tier nodes that are semantically connected to and positioned downstream of the “Policy” node 602. The “Claims History” node 618 is a third tier node that is semantically connected to and positioned downstream of the “Insured Party” node 604. The “Coverage Clause” node 620 and the “Exclusion Clause” node 622 are third tier nodes that are semantically connected to and positioned downstream of the “Coverage Item” node 606. The “Limit” node 624 and the “Deductible” node 626 are fourth tier nodes that are semantically connected to and positioned downstream of the “Coverage Clause” node 620. Table 2 below provides a listing of the aforementioned relations and/or edges of the knowledge graph 600, along with an associated source, target, and description for each such relation and/or edge.

TABLE 2
Relations (Edges)

| Relation | Source | Target | Description |
|---|---|---|---|
| Has Insured | Policy | Insured | Links to insured entity. |
| Party | | Party | |
| Covers | Policy | Coverage | Indicates what is being |
| | | Item | insured. |
| Has Insurer | Policy | Insurer | Links to the underwriting |
| | | | company. |
| Has | Policy | Premium | Links to payment obligation. |
| Premium | | | |
| Modified By | Policy | Endorsement | Points to riders or |
| | | | amendments. |
| Underwritten | Policy | Risk Factor | Risk criteria influencing |
| With | | | approval and pricing. |
| Governed By | Policy | Jurisdiction | Specifies applicable legal |
| | | | context. |
| Has Claims | Insured | Claims | Links to past claims data for |
| History | Party | History | risk modeling. |
| Defined By | Coverage | Coverage | Provides the legal definition |
| | Item | Clause | of the coverage. |
| Excluded By | Coverage | Exclusion | Lists exceptions to coverage. |
| | Item | Clause | |
| Has Limit | Coverage | Limit | Associates financial cap to |
| | Clause | | coverage. |
| Has | Coverage | Deductible | Minimum cost borne by insured. |
| Deductible | Clause | | |

In other examples, the knowledge graph 600 can include additional relations and/or edges beyond those illustrated in FIG. 6. In still other examples, one or more of the relations and/or edges illustrated in FIG. 6 can be omitted from the knowledge graph 600. In still other examples, the one or more of the above-described entity classes and/or nodes may reside and/or be positioned at a tier that differs from the above described tiers, with the associated relations and/or edges being modified accordingly.

Application of the knowledge graph 600 of FIG. 6 to a standard market insurance policy document ingested by the insurance transformation system 100 (e.g., via the document ingestor 102) results in the production of a structured representation of the standard market insurance policy document that can thereafter be utilized by other processing modules of the insurance transformation system 100. For example, a standard market insurance policy document may include information indicating that (1) Acme Corp. is the insured party, (2) the policy covers Building ABC, (3) the policy includes a coverage clause for fire damage, (4) the policy has a limit of $5,000,000, (5) the policy has an annual deductible of $10,000, (6) the policy carries an exclusion clause for earthquakes, (7) Big Carrier Inc. is the insurer, (8) the policy has an annual premium of $25,000, (9) the policy is modified by an endorsement that adds cyber coverage, and (10) the policy is governed by the laws of California. In such an example, application of the knowledge graph 600 of FIG. 6 might generate, provide, output, and/or otherwise result in the following structured representation:

```
{
  Has_Insured_Party → Acme_Corp.
  Covers → Building_ABC
    Defined_By → Coverage_Clause_Fire_Damage
      Has_Limit → $5,000,000
      Has_Deductible → $10,000
    Excluded_By → Exclusion_Clause_Earthquake
  Has_Insurer → Big_Carrier_Inc.
  Has_Premium → $25,000
  Modified_By → Endorsement_Add_Cyber_Coverage
  Governed_By → CA
}
```

The knowledge graph 600 of FIG. 6 can be implemented using RDF, OWL, or in a graph database such as Neo4j or AWS Neptune. SPARQL or Cypher queries can be used to retrieve clauses, compliance risk, or matching policy templates. The ontology of the knowledge graph 600 allows AI models to infer coverage gaps, calculate deductible-exclusion intersections, and/or simulate claim scenarios.

In some examples, the insurance transformation system 100 of FIG. 1 trains its machine learning models using a specialized, domain-specific pipeline that significantly improves performance, adaptability, and reliability. For example, the insurance transformation system 100 implements unsupervised clustering techniques that categorize insurance policies based on policy type, industry vertical, or coverage characteristics, thereby reducing noise and promoting targeted learning. As another example, the insurance transformation system 100 implements paired training datasets that are created by aligning historical standard market policies with expert-authored captive policy equivalents, thereby providing direct transformation examples for supervised learning. As another example, the insurance transformation system 100 implements domain-specific data augmentation that generates synthetic policy variations (e.g., clause rewrites, reinsurance insertions, etc.) to increase training set diversity and generalizability. As another example, the insurance transformation system 100 implements expert-in-the-loop review cycles that feed corrective guidance and override actions back into the model, enabling continuous, active learning that adapts over time. The pipeline and/or workflow of the insurance transformation system 100 is optimized for legal and actuarial document modeling—distinct from standard NLP datasets—and provides a technically distinct and improved methodology for training insurance-specific AI systems.

In some examples, the insurance transformation system 100 of FIG. 1 includes a layered AI architecture that advances beyond standard machine learning models through targeted optimizations in preprocessing, model design, and result validation. For example, the insurance transformation system 100 incorporates a hybrid OCR/NLP preprocessing module designed specifically for insurance documents. In some examples, the hybrid OCR/NLP preprocessing module includes (1) OCR models trained on multi-column formats, dense legal tables, and non-standard typography common in policy declarations and endorsements, and (2) fine-tuned NLP models that leverage domain-specific tokenizers, entity recognition, and syntactic parsing customized for insurance clauses (e.g., identifying layered deductibles, exclusions, retroactive dates, conditional coverage terms, etc.). These improvements ensure more accurate data extraction, particularly from legacy scanned documents, reducing the error rate and improving the reliability of the downstream model.

As another example of the layered AI architecture, the core proposal-generation model of the insurance transformation system 100 is trained using multi-objective loss functions that incorporate compliance and risk alignment. These functions penalize (1) generated clauses that violate jurisdictional insurance regulations, (2) mismatches between stated coverages and inferred risk profiles, and (3) deviations from client financial tolerances unless explicitly authorized. This tailoring of the model's objective function represents a functional enhancement that improves the reliability and domain-alignment of AI outputs.

As another example of the layered AI architecture, the insurance transformation system 100 implements automated validation and an associated feedback loop. After each proposal is generated, the insurance transformation system 100 automatically validates the proposal against (1) the original policy terms, (2) the governing jurisdiction's regulatory rules, and (3) financial viability rules derived from the user's risk profile. A validation engine (e.g., either a rule-based or secondary ML-based model implemented by the validation engine 114 of FIG. 1 described above) flags inconsistencies and triggers proposal regeneration if errors are detected. This feedback loop ensures accuracy, mitigates hallucinations, and continuously improves the model.

In some examples, the insurance transformation system 100 of FIG. 1 departs from traditional SaaS implementations through its use of distributed, real-time microservices optimized for responsiveness and concurrency. For example, the insurance transformation system 100 breaks down the full proposal generation workflow (e.g., OCR, NLP, policy categorization, clause transformation, validation, and compliance checks) into independent, containerized services that execute asynchronously. Components communicate via a message bus or event-driven task queue (e.g., Apache Kafka or RabbitMQ), allowing downstream modules to begin execution as soon as partial data becomes available. This reduces total processing time and supports high user concurrency, enabling near-instant proposal feedback and a responsive user interface.

As another example, the insurance transformation system 100 implements scalable and adaptive model deployment. Model inference is orchestrated through a dynamic model-serving layer that (1) automatically selects between lightweight and full-sized models based on input complexity, (2) scales model containers up or down in Kubernetes or equivalent orchestration environments depending on load, and (3) supports hybrid deployments with certain modules executing client-side for security or latency reasons (e.g., redaction or filtering). This infrastructure represents a technological improvement in the reliability and scalability of AI-based document transformation systems.

In some examples, the insurance transformation system 100 of FIG. 1 incorporates advanced security, auditability, and regulatory alignment features that go well beyond industry norms. For example, the insurance transformation system 100 implements tenant-level data isolation in which each user or organization session operates within an isolated container or virtualized enclave. Policy data remains segregated across clients both in transit and at rest. Memory is encrypted, and decryption occurs exclusively within secure memory contexts (e.g., Intel SGX or similar), preventing data leakage between tenants. As another example, the insurance transformation system 100 implements an integrated compliance and audit module in which a real-time compliance engine cross-references proposed coverage terms against a curated rules database including (1) state and federal regulatory codes, (2) IRS and NAIC captive rules, and (3) internal underwriting constraints and actuarial limits. Any deviations are flagged, and the proposal is either revised or annotated for legal review. Additionally, all proposals and transformation decisions are recorded in an immutable, timestamped audit log with cryptographic signatures. This provides traceability, supports regulatory filings, and ensures accountability in AI-driven policy generation. As another example, the insurance transformation system 100 implements explainable AI outputs in which each AI-generated proposal includes embedded justifications. The insurance transformation system 100 links each transformed clause to (1) its source clause in the original document, (2) the transformation logic (e.g., risk adjustment, coverage normalization), and (3) the applicable regulation or rule used to justify the change. This explainability not only increases user trust, but also supports regulatory review and defensibility, providing a concrete technical mechanism for transparency in AI outputs.

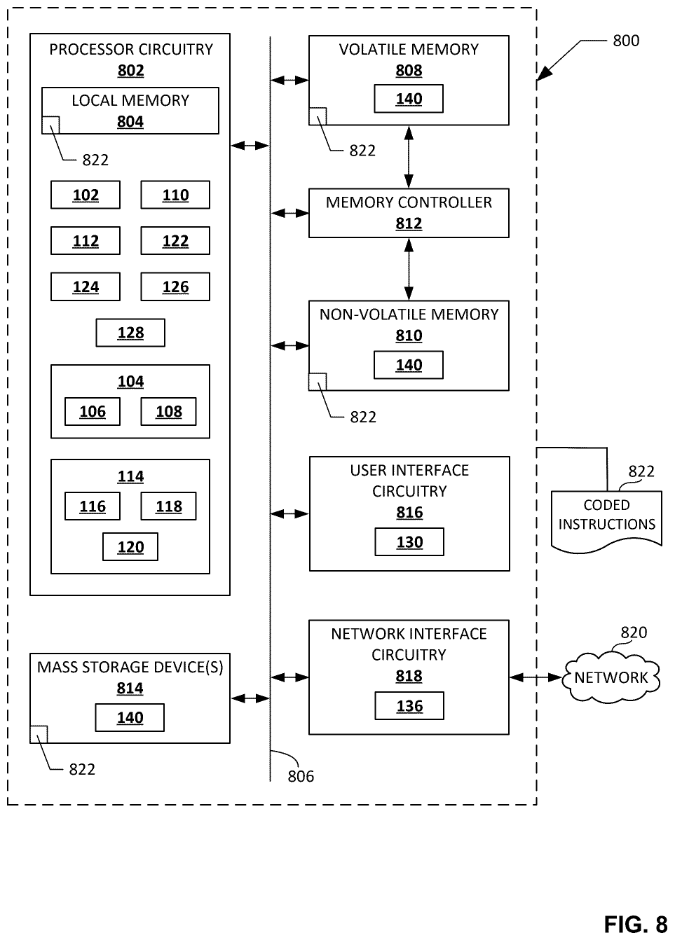

A flowchart representing example machine-readable instructions, which may be executed to configure processor circuitry to implement the insurance transformation system of FIG. 1, is shown in FIG. 7. The machine-readable instructions may be one or more executable program(s) or portion(s) thereof for execution by processor circuitry, such as the processor circuitry 802 shown in the example processor platform 800 discussed below in connection with FIG. 8. The program(s) may be embodied in software stored on one or more non-transitory computer readable storage media such as an optical storage device, a magnetic storage device, a floppy disk drive, a hard disk drive (HDD), a solid state storage device, a flash memory, a read-only memory (ROM), a random-access memory (RAM), a volatile memory, a non-volatile memory, a cache, a CD, a DVD, a Blu-ray disk, and/or any other tangible storage device or tangible storage disk associated with processor circuitry located in one or more hardware device(s). Alternatively, the entire program(s) and/or the portion(s) thereof could be executed by one or more hardware device(s) other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer-readable storage media may include one or more medium(s) located in one or more hardware device(s). Further, although example programs are described with reference to the flowchart illustrated in FIG. 7, many other methods of implementing the example insurance transformation system 100 of FIG. 1 may alternatively be used. For example, the order of execution of the blocks may be changed, and/or some of the blocks described may be changed, eliminated, or combined. Additionally, or alternatively, any or all of the blocks may be implemented by one or more hardware circuit(s) (e.g., processor circuitry) and/or hardware device(s) structured to perform the corresponding operation(s) without executing software or firmware. The hardware circuit(s) and/or hardware device(s) can be located on a single machine, or can be located across multiple machines in different network locations.

The machine-readable instructions described herein may be stored in one or more of a compressed format, an encrypted format, a fragmented format, a compiled format, an executable format, a packaged format, etc. Machine-readable instructions as described herein may be stored as data or a data structure (e.g., as portions of instructions, code, representations of code, etc.) that may be utilized to create, manufacture, and/or produce machine-executable instructions. For example, the machine-readable instructions may be fragmented and stored on one or more storage device(s) and/or computing device(s) (e.g., one or more server(s)) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or any other machine. For example, the machine-readable instructions may be stored in multiple parts, which are individually compressed, encrypted, and/or stored on separate computing devices, wherein the parts when decrypted, decompressed, and/or combined form a set of machine-executable instructions that implement one or more operation(s) that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or any other device. In another example, the machine-readable instructions may need to be configured (e.g., settings stored, data input, network addresses recorded, etc.) before the machine-readable instructions and/or the corresponding program(s) can be executed in whole or in part. Thus, machine-readable media, as used herein, may include machine-readable instructions and/or program(s) regardless of the particular format or state of the machine-readable instructions and/or program(s) when stored or otherwise at rest or in transit. The machine-readable instructions described herein can be represented by any past, present, or future instruction language, scripting language, programming language, etc. For example, the machine-readable instructions may be represented using any of the following languages: C, C++, C#, Java, JavaScript, Python, Perl, HyperText Markup Language (HTML), Structured Query Language (SQL), Non-relational SQL (NoSQL), Swift, etc.

As mentioned above, the example operations of FIG. 7 may be implemented using executable instructions (e.g., computer and/or machine-readable instructions) stored on one or more non-transitory computer and/or machine-readable media such as an optical storage device, a magnetic storage device, a hard disk drive (HDD), a solid state storage device, a flash memory, a read-only memory (ROM), a random-access memory (RAM), a volatile memory, a non-volatile memory, a cache, a CD, a DVD, a Blu-ray disk, and/or any other tangible storage device or tangible storage disk in which information is stored for any duration (e.g., permanently, for extended time periods, for brief instances, for temporarily buffering, and/or for caching of the information).

FIG. 7 is a flowchart representative of example machine-readable instructions and/or example operations 700 that may be executed by processor circuitry to implement the insurance transformation system 100 of FIG. 1. The machine-readable instructions and/or operations 700 of FIG. 7 begin at Block 702 when the processor circuitry of the insurance transformation system 100 ingests, intakes, and/or receives one or more standard market insurance policy document(s). For example, the document ingestor 102 of FIG. 1 ingests, intakes, and/or receives one or more standard market insurance policy document(s) that is/are uploaded and/or otherwise transferred or transmitted to the insurance transformation system 100. Each standard market insurance policy document ingested and/or received by and/or at the document ingestor 102 can itself constitute a standard market insurance policy (or a plurality of standard market insurance policies) or, more broadly, can include information and/or data associated with a standard market insurance policy (or a plurality of standard market insurance policies). Standard market insurance policy documents can be ingested and/or received by the document ingestor 102 either one at a time or as a batch, with such documents including similar and/or mixed policy types (e.g., auto, property, cyber, etc.). Standard market insurance policy documents ingested and/or received by the document ingestor 102 can be structured and/or organized according to any file and/or data structure format including, for example, Portable Document Format (PDF), Joint Photographic Experts Group (JPEG) format, Portable Network Graphics (PNG) format, etc. The intake and/or transfer of standard market insurance policy documents by and/or to the document ingestor 102 of FIG. 1 can be facilitated by the user interface 130 (e.g., including the input device(s) 132 and the output device(s) 134) and/or the network interface 136 of the insurance transformation system 100 of FIG. 1, and can be assisted by a user (e.g., an insurance broker, an insurance client, a system administrator, etc.) having authorization to access the insurance transformation system 100. Following Block 702, control of the machine-readable instructions and/or operations 700 of FIG. 7 proceeds to Block 704.

At Block 704, the processor circuitry of the insurance transformation system 100 extracts structured policy data from the standard market insurance policy document(s). For example, the extraction engine 104 of FIG. 1 reads, digitizes, and/or otherwise interprets the standard market insurance policy document(s) ingested and/or received (e.g., at Block 702) by and/or at the document ingestor 102. In conjunction with Block 704, the document recognition manager 106 of the extraction engine 104 implements and/or utilizes optical character recognition (OCR) to convert the standard market insurance policy document(s) ingested and/or received by and/or at the document ingestor 102 into machine-readable text. In further conjunction with Block 704, the natural language processing manager 108 of the extraction engine 104 implements and/or utilizes natural language processing (NLP) to interpret the meaning and/or context of the machine-readable text identified, generated, and/or output by the document recognition manager 106 of the extraction engine 104. The operations performed at Block 704 are supported, assisted, guided, and/or driven by AI, ML, and/or other algorithmic techniques that are trained and/or otherwise configured to identify and extract structured policy data (e.g., one or more structured data field(s)) from the standard market insurance policy document(s) ingested and/or received by and/or at the document ingestor 102. For example, the extraction engine 104 can implement and/or utilize AI, ML, and/or other algorithmic techniques that are trained and/or otherwise configured to identify and extract policy numbers, insured names, effective dates, premiums, coverage limits, deductible amounts, etc. from the standard market insurance policy document(s) ingested and/or received by and/or at the document ingestor 102. In some examples, the extraction engine 104 can additionally or alternatively invoke, implement, execute, and/or apply a knowledge graph (e.g., the knowledge graph 600 of FIG. 6) in connection with extracting the structured policy data at Block 704. Following Block 704, control of the machine-readable instructions and/or operations 700 of FIG. 7 proceeds to Block 706.

At Block 706, the processor circuitry of the insurance transformation system 100 categorizes the standard market insurance policy document(s). For example, the category manager 110 of FIG. 1 categorizes (e.g., identifies, sorts, and groups) the standard market insurance policy documents ingested and/or received (e.g., at Block 702) by and/or at the document ingestor 102 according to policy type (e.g., auto, property, cyber, etc.). In some examples, the operations performed at Block 706 incorporate, implement, and/or otherwise utilize data processed, generated and/or output (e.g., at Block 704) by the document recognition manager 106, the natural language processing manager 108, and/or, more generally, the extraction engine 104 of FIG. 1. The operations performed at Block 706 are supported, assisted, guided, and/or driven by AI, ML, and/or other algorithmic techniques that are trained and/or otherwise configured to identify a policy type (or multiple policy types) associated with each standard market insurance policy document ingested and/or received (e.g., at Block 702) by and/or at the document ingestor 102. Either in conjunction with or subsequent to the aforementioned identification operation, the category manager 110 sorts each standard market insurance document based on the identified policy type thereof. Either in conjunction with or subsequent to the aforementioned sorting operation, the category manager 110 groups together respective ones of the sorted standard market insurance documents having a common (e.g., same) policy type. Different groups of standard market insurance documents categorized by the category manager 110 of FIG. 1 are maintained as separate batches for the purpose of generating one or more captive insurance policy proposal(s). Following Block 706, control of the machine-readable instructions and/or operations 700 of FIG. 7 proceeds to Block 708.

At Block 708, the processor circuitry of the insurance transformation system 100 prioritizes the standard market insurance policy document(s). For example, the priority manager 112 of FIG. 1 prioritizes (e.g., ranks) the standard market insurance policy documents ingested and/or received (e.g., at Block 702) by and/or at the document ingestor 102 according to one or more parameter(s) (e.g., user-defined or system-defined parameter(s)) and/or according to potential risk exposure, thereby ensuring that policies having a relatively high time sensitivity and/or level of risk are prioritized for processing (e.g., processed ahead of other policies having a relatively lower time sensitivity and/or level of risk) by other components of the insurance transformation system 100. In some examples, the operations performed at Block 708 incorporate, implement, and/or otherwise utilize data processed, generated and/or output (e.g., at Block 704) by the document recognition manager 106, the natural language processing manager 108, and/or, more generally, the extraction engine 104 of FIG. 1. The operations performed at Block 708 are supported, assisted, guided, and/or driven by AI, ML, and/or other algorithmic techniques that are trained and/or otherwise configured to determine (e.g., to identify, calculate, compute, and or correlate) a priority ranking associated with each standard market insurance policy document ingested and/or received by and/or at the document ingestor 102. Either in conjunction with or subsequent to the aforementioned determination operation, the priority manager 112 ranks (e.g., integrates into an ordered listing) each standard market insurance document based on the determined priority rank thereof. Standard market insurance documents prioritized (e.g., ranked) by the priority manager 112 of FIG. 1 are subsequently processed according to (e.g., in order of, with highest priority first) their designated priorities (e.g., determined rankings) in connection with generating one or more captive insurance policy proposal(s). Following Block 708, control of the machine-readable instructions and/or operations 700 of FIG. 7 proceeds to Block 710.

At Block 710, the processor circuitry of the insurance transformation system 100 validates the structured policy data. For example, the validation engine 114 of FIG. 1 validates the structured policy data extracted (e.g., at Block 704) by the extraction engine 104. The validation operations performed at Block 710 advantageously ensure that critical data (e.g., structured policy data, such as policy numbers, insured names, effective dates, premiums, coverage limits, deductible amounts, etc.) is accurate and complete prior to the generation of one or more captive insurance policy proposal(s) that is/are developed from actuarial models which incorporate such critical data as inputs thereto. Utilizing such validated critical data in conjunction with such actuarial models advantageously improves the accuracy and/or reliability of the captive insurance policy proposal(s) generated by the insurance transformation system 100. In conjunction with Block 710, the discrepancy evaluator 116 of the validation engine 114 implements AI, ML, and/or other algorithmic techniques that are trained and/or otherwise configured to identify discrepancies (e.g., missing, inconsistent, and/or incorrect data) located within the structured policy data, and to provide contextual guidance to assist with the correction of such discrepancies.

In some examples, the identified discrepancies and contextual guidance generated and/or output (e.g., at Block 710) by the discrepancy evaluator 116 are fed as inputs to the interactive correction manager 118 of the validation engine 114. In such examples, the interactive correction manager 118 implements (e.g., in conjunction with the user interface 130 and/or the network interface 136 of FIG. 1) an interactive correction session with a user (e.g., an insurance broker, an insurance client, a system administrator, etc.) in which the identified discrepancies and contextual guidance are presented to the user along with one or more prompt(s), indication(s), suggestion(s), and/or request(s) inviting the user to either confirm that the referenced structured policy data is correct, or to instead acknowledge that the referenced structured policy data is missing, incomplete, inconsistent, and/or incorrect, and to input additional and/or new information for the purpose of providing corrected data for the referenced structured policy data. In some such examples, the interactive correction session implemented at Block 710 is supported, assisted, guided, and/or driven by AI, ML, and/or other algorithmic techniques that are trained and/or otherwise configured to conduct such an interactive correction session.

In other examples, the identified discrepancies and contextual guidance generated and/or output (e.g., at Block 710) by the discrepancy evaluator 116 are additionally or alternatively fed as inputs to the auto-correction manager 120 of the validation engine 114. In such examples, the auto-correction manager 120 implements AI, ML, and/or other algorithmic techniques that are trained and/or otherwise configured to either confirm that the referenced structured policy data is correct, or to instead acknowledge that the referenced structured policy data is missing, incomplete, inconsistent, and/or incorrect, and to automatically input additional and/or new information for the purpose of providing corrected data for the referenced structured policy data. Following Block 710, control of the machine-readable instructions and/or operations 700 of FIG. 7 proceeds to Block 712.

At Block 712, the processor circuitry of the insurance transformation system 100 implements one or more interactive discussion session(s) in relation to the extracted and validated structured policy data associated with the standard market insurance policy document(s). For example, the interactive discussion manager 122 of FIG. 1 implements (e.g., in conjunction with the user interface 130 and/or the network interface 136 of FIG. 1) an interactive discussion session with a user (e.g., an insurance broker, an insurance client, a system administrator, etc.) in which the user is able to engage in real-time interaction with the insurance transformation system 100 for various purposes. As one such example, utilizing the interactive discussion session implemented at Block 712, a user can query the insurance transformation system for policy details, request clarification and/or modification of policy details, explore different scenarios in relation to a policy, and/or resolve ambiguities in relation to a policy. In some examples, the operations performed at Block 712 incorporate, implement, and/or otherwise utilize data processed, generated and/or output (e.g., at Block 704 and/or Block 710) by the extraction engine 104 and/or the validation engine 114 of FIG. 1. For example, utilizing the interactive discussion session implemented at Block 712, a user can query, request clarification and/or modification of, explore different scenarios in relation to, and/or resolve ambiguities in relation to the extracted and validated structured policy data that has already been processed, generated and/or output by the extraction engine 104 and/or the validation engine 114 of the insurance transformation system 100. In some examples, the interactive discussion manager 122 causes the presentation of one or more prompt(s), indication(s), suggestion(s), and/or request(s) inviting and/or encouraging the user to engage the insurance transformation system 100 in conjunction with the interactive discussion session. In some such examples, the interactive discussion session implemented at Block 712 is supported, assisted, guided, and/or driven by AI, ML, and/or other algorithmic techniques that are trained and/or otherwise configured to conduct such an interactive discussion session. Following Block 712, control of the machine-readable instructions and/or operations 700 of FIG. 7 proceeds to Block 714.

At Block 714, the processor circuitry of the insurance transformation system 100 generates one or more captive insurance policy proposal(s). For example, the captive insurance proposal generator 124 of FIG. 1 implements actuarial models and business rules that are configured to generate one or more captive insurance policy proposal(s) based on the extracted and validated structured policy data that has already been processed, generated, and/or output (e.g., at Block 704 and/or Block 710) by the extraction engine 104 and/or the validation engine 114 of the insurance transformation system 100. The actuarial models and/or business rules implemented at Block 714 account for factors such as premium structures, deductible levels, reinsurance requirements, and investment performance. The actuarial models and/or business rules implemented at Block 714 also evaluate the financial risk profile and projected surplus over a predetermined and/or user-specified time period (e.g., five years) to generate a captive insurance policy proposal that is customized and/or tailored to the business need of the business entity that may ultimately implement and/or own the captive insurance policy that is the subject of the proposal. In some examples, the actuarial models and/or business rules implemented at Block 714 are supported, assisted, guided, and/or driven by AI, ML, and/or other algorithmic techniques that are trained and/or otherwise configured to generate one or more captive insurance policy proposal(s) based on structured policy data that has been extracted (e.g., at Block 704) by the extraction engine 104 and/or validated (e.g., at Block 710) by the validation engine 114 of the insurance transformation system 100. Following Block 714, control of the machine-readable instructions and/or operations 700 of FIG. 7 proceeds to Block 716.

At Block 716, the processor circuitry of the insurance transformation system 100 implements one or more interactive adjustment session(s) in relation to the captive insurance policy proposal(s). For example, the interactive adjustment manager 126 of FIG. 1 implements (e.g., in conjunction with the user interface 130 and/or the network interface 136 of FIG. 1) an interactive adjustment session with a user (e.g., an insurance broker, an insurance client, a system administrator, etc.) in which the user is able to engage in real-time interaction with a captive insurance policy proposal generated (e.g., at Block 714) by the captive insurance proposal generator 124 of FIG. 1. As one such example, utilizing the interactive adjustment session implemented at Block 716, a user can simulate different risk scenarios by adjusting and/or modifying one or more data value(s) associated with one or more data source(s) (e.g., premium amounts, deductible amounts, surplus amounts, reinsurance amounts, investment rates and/or amounts, etc.) that is/are included in a captive insurance policy proposal generated (e.g., at Block 714) by the captive insurance proposal generator 124 of FIG. 1. The captive insurance proposal generator 124 dynamically recalculates and regenerates an updated version of the previously-generated captive insurance policy proposal in real-time, with such recalculation(s) and/or regeneration(s) being based on the adjustment(s) and/or modification(s) requested by the user during the interactive adjustment session. The recalculated and/or regenerated captive insurance policy proposal is presented to the user in real-time in conjunction with the interactive adjustment session implemented by the interactive adjustment manager 126 so that the user can immediately visualize, interpret, and/or otherwise determine the financial impact of the requested adjustment(s) and/or modification(s) associated with various ones of the different simulated risk scenarios. In some examples, the operations performed at Block 716 by the interactive adjustment manager 126 cause the presentation of one or more prompt(s), indication(s), suggestion(s), and/or request(s) inviting and/or encouraging the user to engage a captive insurance policy proposal in conjunction with the interactive adjustment session. In some such examples, the interactive adjustment session implemented at Block 716 is supported, assisted, guided, and/or driven by AI, ML, and/or other algorithmic techniques that are trained and/or otherwise configured to conduct such an interactive adjustment session. Following Block 716, control of the machine-readable instructions and/or operations 700 of FIG. 7 proceeds to Block 718.

At Block 718, the processor circuitry of the insurance transformation system 100 implements one or more client engagement feature(s) in relation to the captive insurance policy proposal(s). For example, the client engagement manager 128 of FIG. 1 implements one or more client engagement feature(s) in relation to each captive insurance policy proposal that had been generated (e.g., at Block 714) by the captive insurance proposal generator 124 of FIG. 1 and subsequently finalized (e.g., accepted and/or authorized by an insurance broker to be delivered to an insurance client). In some examples, the client engagement manager 128 prepares and/or otherwise generates an email including a summary of a captive insurance policy proposal generated (e.g., at Block 714) by the captive insurance proposal generator 124, and attaches a PDF version of the captive insurance policy proposal to the prepared email. A recipient email address is then added to the prepared email, either via user (e.g., insurance broker) interaction with the client engagement manager 128 and/or, more generally, with the insurance transformation system 100, or automatically from an archived mailing list accessed by the client engagement manager 128. The client engagement manager 128 also facilitates the transmission and/or delivery of prepared emails to their intended and/or targeted recipients (e.g., insurance clients). In some examples, the client engagement manager 128 also facilitates the scheduling of one or more follow-up reminder(s) in relation to any captive insurance policy proposal that has been transmitted and/or delivered to its intended and/or targeted recipient. In some examples, the client engagement manager 128 also logs the various email and scheduling activities facilitated by the client engagement manager 128, thereby providing a historical record of client engagement activities (e.g., client interactions) with full visibility and/or transparency in relation thereto. Such data can be utilized to assist insurance brokers in identifying actionable insights on follow-ups and client interest. Following Block 718, the machine-readable instructions and/or operations 700 of FIG. 7 end.

FIG. 8 is a block diagram of an example processor platform 800 including processor circuitry structured to execute and/or instantiate the machine-readable instructions and/or operations 700 of FIG. 7 to implement the insurance transformation system 100 of FIG. 1. The processor platform 800 of the illustrated example includes processor circuitry 802. The processor circuitry 802 of the illustrated example is hardware. For example, the processor circuitry 802 includes any type(s) and/or any number(s) of processor(s), microprocessor(s), controller(s), microcontroller(s), ASIC(s), PLD(s), FPLD(s), FPGA(s), DSP(s), GPU(s), CPU(s), semiconductor-based (e.g., silicon-based) circuit(s), digital circuit(s), analog circuit(s), logic circuit(s), and/or integrated circuit(s) implemented by any type(s) and/or any number(s) of transistor(s), capacitor(s), diode(s), inductor(s), resistor(s), timer(s), counter(s), printed circuit board(s), connector(s), wire(s), and/or other electrical circuit component(s). In this example, the processor circuitry 802 implements the document ingestor 102, the extraction engine 104 (e.g., including the document recognition manager 106 and the natural language processing manager 108), the category manager 110, the priority manager 112, the validation engine 114 (e.g., including the discrepancy evaluator 116, the interactive correction manager 118, and the auto-correction manager 120), the interactive discussion manager 122, the captive insurance proposal generator 124, the interactive adjustment manager 126, and the client engagement manager 128 of FIG. 1.

The processor circuitry 802 of the illustrated example includes a local memory 804 (e.g., a cache, registers, etc.). The processor circuitry 802 is in electrical communication with a main memory via a bus 806, with the main memory including a volatile memory 808 and a non-volatile memory 810. The volatile memory 808 may be implemented by any type of random-access memory (RAM) (e.g., Synchronous Dynamic Random Access Memory (SDRAM), Dynamic Random Access Memory (DRAM), RAMBUS® Dynamic Random Access Memory (RDRAM®), etc.). The non-volatile memory 810 may be implemented by flash memory and/or any other desired type of memory device. Access to the main memory 808, 810 of the illustrated example is controlled by a memory controller 812.

The processor platform 800 of the illustrated example also includes one or more mass storage device(s) 814 to store software and/or data. Examples of such mass storage device(s) 814 include an optical storage device, a magnetic storage device, a floppy disk drive, a hard disk drive (HDD), a solid state storage device, a flash memory device, a read-only memory (ROM), a random-access memory (RAM), a cache, a CD, a DVD, a Blu-ray disk, and/or any other tangible storage device or tangible storage disk in which information is stored for any duration (e.g., permanently, for extended time periods, for brief instances, for temporarily buffering, and/or for caching of the information). In the illustrated example of FIG. 8, one or more of the volatile memory 808, the non-volatile memory 810, and/or the mass storage device(s) 814 implement(s) the memory 140 of FIG. 1.

The processor platform 800 of the illustrated example also includes user interface circuitry 816. The user interface circuitry 816 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. In the illustrated example of FIG. 8, the user interface circuitry 816 implements and/or is in electrical communication with the user interface 130 of FIG. 1, including the input device(s) 132 and/or the output device(s) 134 thereof.

The processor platform 800 of the illustrated example also includes network interface circuitry 818. The network interface circuitry 818 includes one or more communication device(s) (e.g., transmitter(s), receiver(s), transceiver(s), modem(s), gateway(s), wireless access point(s), etc.) to facilitate exchange of data with external machines (e.g., computing devices of any kind, including the remote device(s) 142 of FIG. 1) by a network 820. The communication can be by, for example, a satellite system, a wireless system, a cellular telephone system, an Ethernet connection, a digital subscriber line (DSL) connection, a telephone line connection, a coaxial cable system, an optical connection, etc. In the illustrated example of FIG. 8, the network interface circuitry 818 implements the network interface 136 of FIG. 1, including the communication device(s) 138 thereof.

Coded instructions 822 including the above-described machine-readable instructions and/or operations 700 of FIG. 7 may be stored in the local memory 804, in the volatile memory 808, in the non-volatile memory 810, on the mass storage device(s) 814, and/or on a removable non-transitory computer-readable storage medium such as a flash memory stick, a dongle, a CD, a DVD, or a Blu-ray disk.

The following paragraphs provide various examples in relation to the disclosed AI-supported interactive platforms for generating captive insurance policy proposals based on standard market insurance policy data.

Example 1 includes a system. In Example 1, the system includes memory, machine-readable instructions, and one or more processors. The one or more processors are configured to execute the machine-readable instructions to ingest one or more standard market insurance policy documents. The one or more processors are further configured to execute the machine-readable instructions to extract structured policy data from the one or more standard market insurance policy documents. The one or more processors are further configured to execute the machine-readable instructions to generate a captive insurance policy proposal based on the structured policy data. The one or more processors are further configured to execute the machine-readable instructions to implement one or more client engagement features configured to facilitate generation of an email that includes the captive insurance policy proposal as an attachment thereto. The one or more client engagement features are further configured to facilitate delivery of the email to a client. The one or more processors are further configured to execute the machine-readable instructions to implement a graphical user interface including a dashboard having one or more dashboard layers. The dashboard includes a first area configured to enable a user of the system to invoke the ingestion of the one or more standard market insurance policy documents. The dashboard further includes a second area configured to enable the user to invoke the generation of the captive insurance policy proposal. The dashboard further includes a third area configured to enable the user to invoke the implementation of the one or more client engagement features.

Example 2 includes the system of Example 1. In Example 2, the first area and the second area are arranged on a first dashboard layer of the dashboard, and the third area is arranged on a second dashboard layer of the dashboard. Presentation of the second dashboard layer is conditioned upon user interaction with the second area of the first dashboard layer.

Example 3 includes the system of Example 2. In Example 3, the dashboard further includes a fourth area configured to enable the user to input one or more client engagement details associated with the one or more client engagement features. The fourth area is arranged on a third dashboard layer of the dashboard. Presentation of the third dashboard layer is conditioned upon user interaction with the third area of the second dashboard layer.

Example 4 includes the system of Example 3. In Example 4, the one or more client engagement details include at least one of a client email address, an email delivery date, or a reminder date.

Example 5 includes the system of Example 3. In Example 5, the one or more processors are further configured to execute the machine-readable instructions to implement a validation engine configured to facilitate review, correction, and approval of the structured policy data. The dashboard includes a fifth area configured to enable user interaction with the validation engine to facilitate review, correction, and approval of the structured policy data.

Example 6 includes the system of Example 5. In Example 6, the fifth area is arranged on the first dashboard layer of the dashboard.

Example 7 includes the system of Example 5. In Example 5, the validation engine is further configured to implement an artificial intelligence model that automatically identifies and corrects one or more errors present in the structured policy data.

Example 8 includes the system of Example 3. In Example 8, the one or more processors are further configured to execute the machine-readable instructions to implement an interactive discussion session associated with the structured policy data. The interactive discussion session is configured to enable the user to query an artificial intelligence model in relation to the structured policy data. The dashboard includes a fifth area configured to enable user interaction with the interactive discussion session.

Example 9 includes the system of Example 8. In Example 9, the fifth area is arranged on the first dashboard layer of the dashboard.

Example 10 includes the system of Example 8. In Example 10, the artificial intelligence model implements a conversational artificial intelligence framework.

Example 11 includes the system of Example 3. In Example 11, the one or more processors are further configured to execute the machine-readable instructions to implement an interactive adjustment session associated with the captive insurance policy proposal. The interactive adjustment session is configured to enable the user to review, adjust, and approve one or more parameters associated with the captive insurance policy proposal. The dashboard includes a fifth area configured to enable user interaction with the interactive adjustment session to facilitate review, adjustment, and approval of the one or more parameters of the captive insurance policy proposal.

Example 12 includes the system of Example 11. In Example 12, the fifth area is arranged on the second dashboard layer of the dashboard.

Example 13 includes the system of Example 11. In Example 13, the one or more parameters include a liability limit amount, a premium amount, a surplus amount, a reinsurance amount, and an investment rate included in the captive insurance policy proposal.

Example 14 includes the system of Example 11. In Example 11, adjustment of at least one of the one or more parameters causes generation of a modified captive insurance policy proposal. The modified captive insurance policy proposal incorporates adjustments associated with adjusted ones of the one or more parameters.

Example 15 includes the system of Example 1. In Example 1, the extraction of the structured policy data includes implementation of a knowledge graph. The knowledge graph includes a plurality of entity classes structured as nodes and a plurality of relations structured as edges. Each entity class from among the plurality of entity classes represents a concept, a clause, or a term commonly found in standard market insurance policies. Each relation from among the plurality of relations semantically connects two entity classes from among the plurality of entity classes. Application of the knowledge graph to a first standard market insurance policy document from among the one or more standard market insurance policy documents results in production of a structured representation of the first standard market insurance policy document

Example 16 includes a system. In Example 16, the system includes memory, machine-readable instructions, and one or more processors. The one or more processors are configured to execute the machine-readable instructions to ingest one or more standard market insurance policy documents. The one or more processors are further configured to execute the machine-readable instructions to extract structured policy data from the one or more standard market insurance policy documents. The one or more processors are further configured to execute the machine-readable instructions to implement a validation engine configured to facilitate review, correction, and approval of the structured policy data. The one or more processors are further configured to execute the machine-readable instructions to implement an interactive discussion session associated with the structured policy data. The interactive discussion session is configured to enable a user of the system to query an artificial intelligence model in relation to the structured policy data. The artificial intelligence model is configured to implement a conversational artificial intelligence framework. The one or more processors are further configured to execute the machine-readable instructions to generate a captive insurance policy proposal based on the structured policy data. The one or more processors are further configured to execute the machine-readable instructions to implement an interactive adjustment session associated with the captive insurance policy proposal. The interactive adjustment session is configured to enable the user to review, adjust, and approve one or more parameters associated with the captive insurance policy proposal. The one or more parameters include at least one of a liability limit amount, a premium amount, a surplus amount, a reinsurance amount, or an investment rate included in the captive insurance policy proposal. The one or more processors are further configured to execute the machine-readable instructions to implement one or more client engagement features configured to facilitate generation of an email that includes the captive insurance policy proposal as an attachment thereto. The one or more client engagement features are further configured to facilitate delivery of the email to a client. The one or more processors are further configured to execute the machine-readable instructions to implement a graphical user interface including a dashboard having one or more dashboard layers. The dashboard includes a first area configured to enable the user to invoke the ingestion of the one or more standard market insurance policy documents. The dashboard further includes a second area configured to enable user interaction with the validation engine to facilitate review, correction, and approval of the structured policy data. The dashboard further includes a third area configured to enable user interaction with the interactive discussion session. The dashboard further includes a fourth area configured to enable the user to invoke the generation of the captive insurance policy proposal. The dashboard further includes a fifth area configured to enable user interaction with the interactive adjustment session to facilitate review, adjustment, and approval of the one or more parameters of the captive insurance policy proposal. The dashboard further includes a sixth area configured to enable the user to invoke the implementation of the one or more client engagement features. The dashboard further includes a seventh area configured to enable the user to input one or more client engagement details associated with the one or more client engagement features. The one or more client engagement details include at least one of a client email address, an email delivery date, or a reminder date.

Example 17 includes the system of Example 16. In Example 17, the first area, the second area, the third area, and the fourth area are arranged on a first dashboard layer of the dashboard, the fifth area and the sixth area are arranged on a second dashboard layer of the dashboard, and the seventh area is arranged on a third dashboard layer of the dashboard. Presentation of the second dashboard layer is conditioned upon user interaction with the fourth area of the first dashboard layer. Presentation of the third dashboard layer is conditioned upon user interaction with the sixth area of the second dashboard layer.

Example 18 includes the system of Example 16. In Example 18, the validation engine is further configured to implement an artificial intelligence model that automatically identifies and corrects one or more errors present in the structured policy data.

Example 19 includes the system of Example 16. In Example 19, adjustment of at least one of the one or more parameters causes generation of a modified captive insurance policy proposal. The modified captive insurance policy proposal incorporates adjustments associated with adjusted ones of the one or more parameters.

Example 20 includes the system of Example 16. In Example 20, the extraction of the structured policy data includes implementation of a knowledge graph. The knowledge graph includes a plurality of entity classes structured as nodes and a plurality of relations structured as edges. Each entity class from among the plurality of entity classes represents a concept, a clause, or a term commonly found in standard market insurance policies. Each relation from among the plurality of relations semantically connects two entity classes from among the plurality of entity classes. Application of the knowledge graph to a first standard market insurance policy document from among the one or more standard market insurance policy documents results in production of a structured representation of the first standard market insurance policy document.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A system, comprising:
memory;
machine-readable instructions; and
one or more processors configured to execute the machine-readable instructions to:
ingest one or more standard market insurance policy documents;
extract structured policy data from the one or more standard market insurance policy documents;
generate a captive insurance policy proposal based on the structured policy data;
implement one or more client engagement features configured to facilitate generation of an email that includes the captive insurance policy proposal as an attachment thereto, the one or more client engagement features further configured to facilitate delivery of the email to a client; and
implement a graphical user interface including a dashboard having one or more dashboard layers, the dashboard including:
a first area configured to enable a user of the system to invoke the ingestion of the one or more standard market insurance policy documents;
a second area configured to enable the user to invoke the generation of the captive insurance policy proposal; and
a third area configured to enable the user to invoke the implementation of the one or more client engagement features.

2. The system of claim 1, wherein the first area and the second area are arranged on a first dashboard layer of the dashboard, and the third area is arranged on a second dashboard layer of the dashboard, wherein presentation of the second dashboard layer is conditioned upon user interaction with the second area of the first dashboard layer.

3. The system of claim 2, wherein the dashboard further includes a fourth area configured to enable the user to input one or more client engagement details associated with the one or more client engagement features, wherein the fourth area is arranged on a third dashboard layer of the dashboard, wherein presentation of the third dashboard layer is conditioned upon user interaction with the third area of the second dashboard layer.

4. The system of claim 3, wherein the one or more client engagement details include at least one of a client email address, an email delivery date, or a reminder date.

5. The system of claim 3, wherein the one or more processors are further configured to execute the machine-readable instructions to implement a validation engine configured to facilitate review, correction, and approval of the structured policy data, wherein the dashboard includes a fifth area configured to enable user interaction with the validation engine to facilitate review, correction, and approval of the structured policy data.

6. The system of claim 5, wherein the fifth area is arranged on the first dashboard layer of the dashboard.

7. The system of claim 5, wherein the validation engine is further configured to implement an artificial intelligence model that automatically identifies and corrects one or more errors present in the structured policy data.

8. The system of claim 3, wherein the one or more processors are further configured to execute the machine-readable instructions to implement an interactive discussion session associated with the structured policy data, wherein the interactive discussion session is configured to enable the user to query an artificial intelligence model in relation to the structured policy data, wherein the dashboard includes a fifth area configured to enable user interaction with the interactive discussion session.

9. The system of claim 8, wherein the fifth area is arranged on the first dashboard layer of the dashboard.

10. The system of claim 8, wherein the artificial intelligence model implements a conversational artificial intelligence framework.

11. The system of claim 3, wherein the one or more processors are further configured to execute the machine-readable instructions to implement an interactive adjustment session associated with the captive insurance policy proposal, wherein the interactive adjustment session is configured to enable the user to review, adjust, and approve one or more parameters associated with the captive insurance policy proposal, wherein the dashboard includes a fifth area configured to enable user interaction with the interactive adjustment session to facilitate review, adjustment, and approval of the one or more parameters of the captive insurance policy proposal.

12. The system of claim 11, wherein the fifth area is arranged on the second dashboard layer of the dashboard.

13. The system of claim 11, wherein the one or more parameters include a liability limit amount, a premium amount, a surplus amount, a reinsurance amount, and an investment rate included in the captive insurance policy proposal.

14. The system of claim 11, wherein adjustment of at least one of the one or more parameters causes generation of a modified captive insurance policy proposal, wherein the modified captive insurance policy proposal incorporates adjustments associated with adjusted ones of the one or more parameters.

15. The system of claim 1, wherein the extraction of the structured policy data includes implementation of a knowledge graph, the knowledge graph including a plurality of entity classes structured as nodes and a plurality of relations structured as edges, wherein each entity class from among the plurality of entity classes represents a concept, a clause, or a term commonly found in standard market insurance policies, wherein each relation from among the plurality of relations semantically connects two entity classes from among the plurality of entity classes, wherein application of the knowledge graph to a first standard market insurance policy document from among the one or more standard market insurance policy documents results in production of a structured representation of the first standard market insurance policy document.

16. A system, comprising:
memory;
machine-readable instructions; and
one or more processors configured to execute the machine-readable instructions to:
ingest one or more standard market insurance policy documents;
extract structured policy data from the one or more standard market insurance policy documents;
implement a validation engine configured to facilitate review, correction, and approval of the structured policy data;
implement an interactive discussion session associated with the structured policy data, the interactive discussion session configured to enable a user of the system to query an artificial intelligence model in relation to the structured policy data, the artificial intelligence model configured to implement a conversational artificial intelligence framework;
generate a captive insurance policy proposal based on the structured policy data;
implement an interactive adjustment session associated with the captive insurance policy proposal, the interactive adjustment session configured to enable the user to review, adjust, and approve one or more parameters associated with the captive insurance policy proposal, the one or more parameters including at least one of a liability limit amount, a premium amount, a surplus amount, a reinsurance amount, or an investment rate included in the captive insurance policy proposal;
implement one or more client engagement features configured to facilitate generation of an email that includes the captive insurance policy proposal as an attachment thereto, the one or more client engagement features further configured to facilitate delivery of the email to a client; and
implement a graphical user interface including a dashboard having one or more dashboard layers, the dashboard including:
a first area configured to enable the user to invoke the ingestion of the one or more standard market insurance policy documents;
a second area configured to enable user interaction with the validation engine to facilitate review, correction, and approval of the structured policy data;
a third area configured to enable user interaction with the interactive discussion session;
a fourth area configured to enable the user to invoke the generation of the captive insurance policy proposal;
a fifth area configured to enable user interaction with the interactive adjustment session to facilitate review, adjustment, and approval of the one or more parameters of the captive insurance policy proposal;
a sixth area configured to enable the user to invoke the implementation of the one or more client engagement features; and
a seventh area configured to enable the user to input one or more client engagement details associated with the one or more client engagement features, the one or more client engagement details including at least one of a client email address, an email delivery date, or a reminder date.

17. The system of claim 16, wherein the first area, the second area, the third area, and the fourth area are arranged on a first dashboard layer of the dashboard, the fifth area and the sixth area are arranged on a second dashboard layer of the dashboard, and the seventh area is arranged on a third dashboard layer of the dashboard, wherein presentation of the second dashboard layer is conditioned upon user interaction with the fourth area of the first dashboard layer, and wherein presentation of the third dashboard layer is conditioned upon user interaction with the sixth area of the second dashboard layer.

18. The system of claim 16, wherein the validation engine is further configured to implement an artificial intelligence model that automatically identifies and corrects one or more errors present in the structured policy data.

19. The system of claim 16, wherein adjustment of at least one of the one or more parameters causes generation of a modified captive insurance policy proposal, wherein the modified captive insurance policy proposal incorporates adjustments associated with adjusted ones of the one or more parameters.

20. The system of claim 16, wherein the extraction of the structured policy data includes implementation of a knowledge graph, the knowledge graph including a plurality of entity classes structured as nodes and a plurality of relations structured as edges, wherein each entity class from among the plurality of entity classes represents a concept, a clause, or a term commonly found in standard market insurance policies, wherein each relation from among the plurality of relations semantically connects two entity classes from among the plurality of entity classes, wherein application of the knowledge graph to a first standard market insurance policy document from among the one or more standard market insurance policy documents results in production of a structured representation of the first standard market insurance policy document.
